(19) United States
(12) Patent Application Publication
(10) Pub. No.: US 2006/0285818 A1
(43) Pub. Date: Dec. 21, 2006

(54) Information processing apparatus, method, and program

(75) Inventor: Noboru Murabayashi, Saitama (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/441,287

(22) Filed: May 25, 2006

(30) Foreign Application Priority Data
May 30, 2005 (JP) P2005-156624

(51) Int. Cl. H04N 5/91

(52) U.S. Cl. 386/46

(57) ABSTRACT

An information processing apparatus for capturing an input stream in a plurality of recording formats and recording a plurality of captured streams on a same recording medium. The information processing apparatus includes an extracting unit operable to extract from the input stream characteristic data representing characteristics of the stream; and a recording unit operable to record the extracted characteristic data, predetermined data based on the extracted characteristic data, or both the extracted characteristic data and the predetermined data as common data representing the characteristics of the streams individually captured in the plurality of recording formats. When the information processing apparatus processes data recorded on a recording medium including a plurality of streams in a plurality of recording formats, if characteristic data is not recorded on the recording medium, the information processing apparatus extracts and records characteristics of the stream, or the like in the same manner as described above.

### CROSS-REFERENCE TO RELATED APPLICATIONS

The present application claims priority from Japanese Patent Application No. JP 2005-156624 filed on May 30, 2005, the disclosure of which is hereby incorporated by reference herein.

### BACKGROUND OF THE INVENTION

The present invention relates to an information processing apparatus, method, and program. More particularly, the present invention relates to an information processing apparatus, method, and program which enable ensuring consistency of characteristic data to be used for processing a plurality of streams recorded in different formats.

To date, hard disks (HDD: Hard Disk Drives) have been used as data recording media for personal computers, etc. As for HDDs, significant progress has been made in increasing the capacity, lowering the cost, and reducing the size thereof. Thus, in recent years, HDDs have been used for various apparatuses as well, for example recording apparatuses, portable music reproduction apparatuses, etc., in addition to personal computers.

Also, optical discs such as a CD (Compact Disk), a DVD (Digital Versatile Disk), etc., have been used for data recording media in addition to HDDs. In recent years, next-generation optical discs having a higher data reading and writing speed and a larger capacity than known DVDs have been proposed. For example, the Blu-ray Disc (a trademark) format (in the following, called the BD) and the HD-DVD (High Definition DVD)(a trademark) format (in the following, called the HD-DVD) have been proposed for formats of the next generation optical discs designed for consumer appliances.

Known DVDs (in the following, called the normal DVDs) are capable of double-sided recording, dual-layer recording, etc. In the case of a DVD-ROM, the recording capacity is 4.7 GB on a single-sided and single-layer disc, 8.5 GB on a single-sided and dual-layer disc, and 9.4 GB on a double-sided and single-layer disc. In contrast, the recording capacity of the BD is 27 GB on a single-sided disc. The transfer rate of the BD is 36 Mbps, and thus it is possible to read data faster than the normal DVD. Moreover, the recording capacity of the HD-DVD is 15 to 20 GB on a single-sided and signal-layer disc, and 30 to 40 GB on a dual-layer disc. This is also a larger recording capacity than the normal DVD.

It is difficult to entirely replace widespread recording/reproducing apparatuses corresponding to the normal DVD with recording/reproducing apparatuses corresponding to the BD and the HD-DVD in a short time. Thus, in recent years, optical discs capable of recording and reproducing data on the BD or the HD-DVD and capable of recording and reproducing data on the normal DVD have also been developed.

It becomes possible to record with higher image quality and for a longer time, etc., as compared with the normal DVD by using a recording layer corresponding to the BD or the HD-DVD out of an optical disc supporting a plurality of recording formats.

Here, as a recording method of video (images), for example a method of recording a same image onto a recording layer corresponding to the BD or the HD-DVD and a recording layer corresponding to the normal DVD individually among an optical disc supporting a plurality of recording formats is considered. Specifically, image data can be recorded onto a recording layer corresponding to the BD or the HD-DVD at a high transfer rate and in a high image-quality mode in consideration of the characteristic having a high transfer rate and a large capacity. On the other hand, the same image data can be recorded onto a recording layer corresponding to the normal DVD at a low transfer rate and in the normal image-quality mode.

In this manner, by recording broadcasting programs, movies, etc., both in a high image-quality mode and in a normal image-quality mode, a user can reproduce, for example the normal DVD data using a portable reproduction device which does not relatively give uncomfortable feeling by poor image quality, and reproduce the BD or the HD-DVD data using a reproduction device of a standalone type at home.

For a reproduction method, two methods are considered rather than just reproducing in the recorded sequence in time series. One method is to reproduce the scenes a user want to see, and the other method is to reproduce only the scenes (key frames) that are considered to be important (digest reproduction). Thus, for example, the user can know the entire recording without viewing, in the recorded sequence, all of the drama series and the series programs that were recorded in succession.

In order to achieve the former special reproduction, Japanese Unexamined Patent Application Publication Nos. 2002-44573 and 2002-344852 have disclosed techniques in which image data is automatically classified for each similar scene using the characteristic data of the recorded images, and typical images are displayed as thumbnail images so as to allow the user to select reproduction positions.

On the other hand, in order to achieve the latter special reproduction, Japanese Unexamined Patent Application Publication No. 2003-219348 has disclosed a technique in which important sections are determined on the basis of the characteristic data of the recorded images, and only the determined important sections are reproduced.

For the processing using characteristic data of images, the setting of so-called chapter points in images is considered. By using image data in which such chapter points are set, the user can perform edit processing, for example cutting out, coping, etc., the images in the range of the specified chapter points.

Incidentally, when the same image is individually recorded on a recording layer corresponding to the BD or the HD-DVD and on a recording layer corresponding to the normal DVD using an optical disc supporting a plurality of recording formats, it is necessary for the characteristic data used when performing thumbnail display of typical images, reproduction of a digest, edit processing, etc., to have consistency between the characteristic data obtained from the images recorded on the recording layer corresponding to the BD and the HD-DVD and the characteristic data obtained from the images recorded on the recording layer corresponding to the normal DVD.

The characteristic data is obtained, for example by being extracted based on characteristics (for example, pixel values) appearing in images, or by using a part of data extracted from the entire data to be encoded at the time of recording the images as the characteristic data. Thus, even when the same images are processed, if the recording formats are different, different data is sometimes obtained as the characteristic data of the individual images recorded in different formats.

In this case, the chapter points and the key-frame positions are different depending on the recording formats. The reproduction position of when a certain section is specified for reproduction by specifying chapter points during the reproduction of the BD or the HD-DVD data becomes different from the reproduction position of when the same section is specified for reproduction by specifying the chapter points during the reproduction of the normal DVD data in spite of the fact that the recorded images are the same.

One of the causes that different data is obtained as characteristic data is the difference in the screen sizes. For example, in the BD and the HD-DVD, recording is carried out using a screen size of 16:9, whereas in the normal DVD, recording is carried out using a screen size of 4:3. The difference in the screen sizes makes the signal characteristics of Y, Cb, Cr different even for the signals of the same image, and thus the characteristic data obtained based on these signals sometimes become different.

Also, for the audio characteristic data, even if the same audio is processed, the characteristic data obtained sometimes become different because of the difference in the quantifying bit numbers, the sampling frequencies, etc., the difference between 5.1-channel surround sound recording and 2-channel stereo recording, etc., and the other factors.

FIGS. 1, A and B and 2, A and B are diagrams illustrating consistency of characteristic data.

The stream shown by FIG. 1, A is a stream of images recorded in the normal DVD format, and the stream shown by FIG. 2, A is a stream of images recorded by the BD format (or the HD-DVD format). In this regard, each one of the quadrilaterals with numerals in FIGS. 1, A and B and 2, A and B represents one scene (a predetermined number of frames).

Suppose that the extraction processing of the characteristic data is performed on the basis of the image stream recorded in the normal DVD format and the image stream recorded in the BD format in a state in which such a stream is recorded. Also, suppose that, for example the scenes 3, 7, and 13 as shown in FIG. 1, B and the scenes 5, 8, and 15 as shown in FIG. 2, B are extracted as the characteristic scenes (key frames), respectively from the result of the extraction processing.

That is to say, although the contents of the recorded image are the same, there is no consistency between the characteristic data, and thus different scenes are extracted as the characteristic scenes.

Since the user performs edit processing, etc., by viewing the typical images of the characteristic scenes extracted based on the characteristic data, if the consistency of the characteristic data is not ensured in this manner, confusion may occur at the time of the edit processing.

For example, when the streams in the same range are individually selected from the image stream recorded in the normal DVD format and the image stream recorded by the BD format in order to be copied to another recording medium, the typical images displayed at the time of the edit processing are different. Thus, it is difficult for the user to correctly select the same range to be copied from the individual streams by viewing the display of the typical images.

Also, when the user instructs digest reproduction, the reproduction position is selected in accordance with the position of the characteristic point set on the basis of the characteristic data. Thus, when the consistency of the characteristic data is not ensured, the reproduction positions are different between the case of reproducing a digest of the image stream recorded in the normal DVD format and the case of reproducing a digest of the image stream recorded in the BD format. Accordingly, the user may feel uncomfortable about the difference.

The present invention has been made in view of such a situation. It is desirable to ensure consistency of the characteristic data to be used for the processing among a plurality of streams recorded in different formats.

### SUMMARY OF THE INVENTION

According to an embodiment of the present invention, there is provided an apparatus including extracting means for extracting from an input stream characteristic data representing characteristics of the stream; and recording means for recording the extracted characteristic data, predetermined data based on the extracted characteristic data, or both the extracted characteristic data and the predetermined data as common data representing the characteristics of the streams individually captured in the plurality of recording formats.

According to another embodiment of the present invention, there is provided an apparatus including, when characteristic data representing characteristics of a stream extracted from the stream is not recorded on a recording medium, extracting means for reading any one of the streams recorded on the recording medium and for extracting characteristic data representing characteristics of the stream from the read stream; and recording means for recording the extracted characteristic data, predetermined data based on the extracted characteristic data, or both the extracted characteristic data and the predetermined data as common data representing the characteristics of the streams individually captured in the plurality of recording formats.

The recording medium may be an optical disc including a plurality of recording layers capable of recording the plurality of captured streams with each recording layer recording a captured stream of a different recording format, and the recording means may record the extracted characteristic data on at least one of the plurality of recording layers.

When a semiconductor memory is provided as a recording area different from the recording layers, the recording means may record the extracted characteristic data on at least one of the plurality of recording layers or the semiconductor memory.

The information processing apparatus may further include generation means for generating special reproduction data to be used at a special reproduction time of the streams recorded on the recording medium as the predetermined data based on the extracted characteristic data.

In an embodiment of the present invention, characteristic data representing the characteristics of the stream is exhausted from an input stream, and the extracted characteristic data, predetermined data based on the extracted characteristic data, or both the extracted characteristic data and the predetermined data is recorded on a recording medium as common data representing the characteristics of the streams individually captured in the plurality of recording formats.

In another embodiment of the present invention, when characteristic data representing the characteristics of the stream extracted from the stream is not recorded on the recording medium, any one of the streams recorded on the recording medium is read, and characteristic data representing the characteristics of the stream is extracted from the read stream. Also, the extracted characteristic data, predetermined data based on the extracted characteristic data, or both the extracted characteristic data and the predetermined data is recorded on a recording medium as common data representing the characteristics of the streams individually captured in the plurality of recording formats.

Information processing methods corresponding to the above apparatus are also provided.

According to the present invention, it is possible to ensure the consistency of the characteristic data to be used for processing among a plurality of streams recorded in different formats.

### BRIEF DESCRIPTION OF THE DRAWINGS

FIG. 1 is a diagram illustrating consistency of characteristic data;

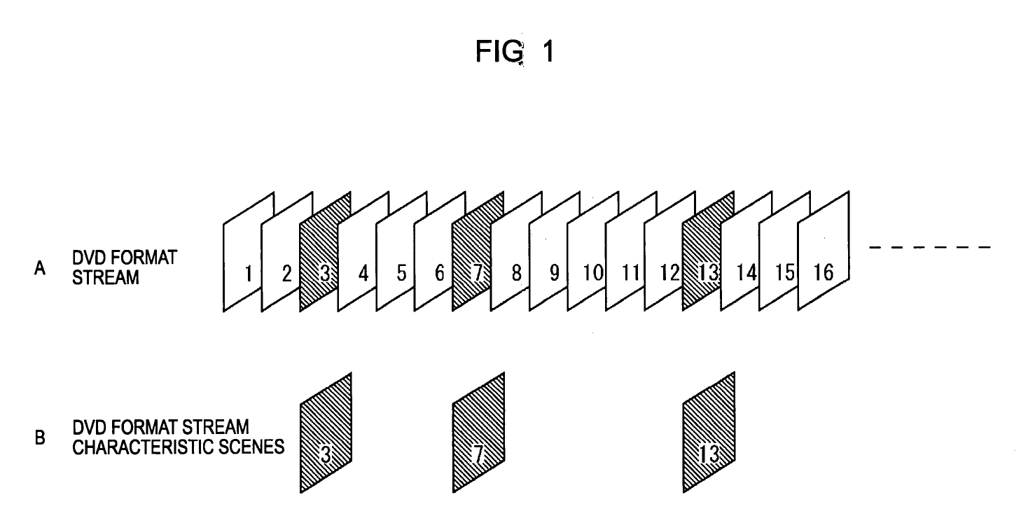

FIG. 2 is another diagram illustrating consistency of characteristic data;

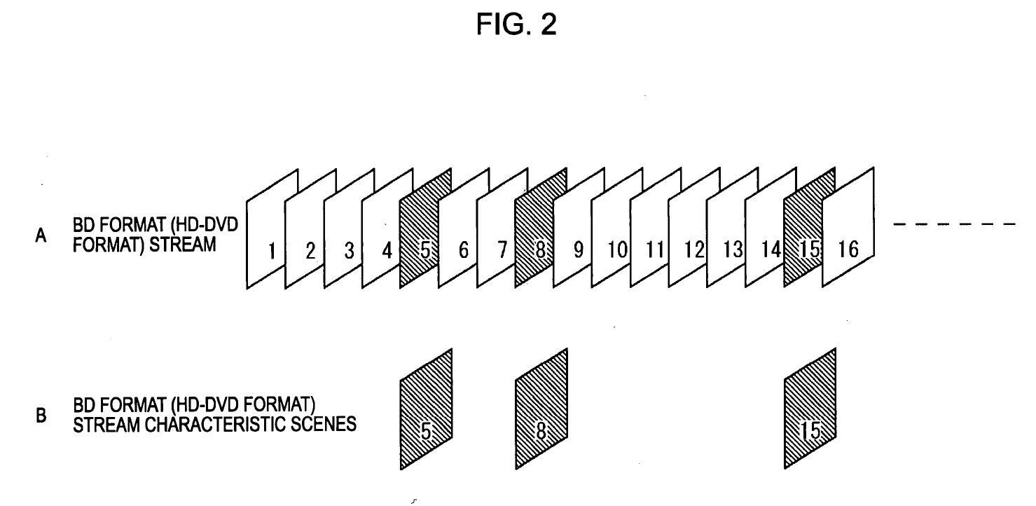

FIG. 3 is a diagram illustrating an example of recording in a two-recording mode;

FIG. 4 is a diagram illustrating another example of recording in a two-recording mode;

FIG. 5 is a diagram illustrating an example of reproduction;

FIG. 6 is a diagram illustrating an example in which playlists are displayed as text data;

FIG. 7 is a diagram illustrating an example of combinations of recording destinations of characteristic data and special reproduction data;

FIG. 8 is a diagram illustrating an example of recording states of characteristic data and playlist data;

FIGS. 9A and 9B are top views of a disc-shaped recording medium.

FIG. 10 is a diagram illustrating another example of combinations of recording destinations of characteristic data and special reproduction data;

FIG. 11 is a block diagram illustrating an example of the configuration of a recording side for recording a same content in a plurality of recording formats;

FIG. 12 is a block diagram illustrating another example of the configuration of a recording side for recording a same content in a plurality of recording formats;

FIG. 13 is a diagram illustrating an example of recording sequences;

FIG. 14 is a diagram illustrating digest reproduction and chapter processing;

FIG. 15 is a diagram illustrating an example of the display of chapter images;

FIG. 16 is a block diagram illustrating an example of the configuration of an overall recording/reproducing apparatus;

FIGS. 17A and 17B are examples of the displays of messages;

FIGS. 18A, 18B, and 18C are examples of the displays of the other messages;

FIG. 19 is a block diagram illustrating another example of the configuration of an overall recording/reproducing apparatus;

FIG. 20 is a block diagram illustrating an example of the configuration for extracting characteristics of an audio system;

FIG. 21 is a block diagram illustrating another example of the configuration for extracting characteristics of an audio system;

FIG. 22 is a block diagram illustrating an example of the configuration for extracting characteristics of a video system;

FIG. 23 is a diagram illustrating an example of areas used for detecting scene changes;

FIG. 24 is a diagram illustrating an example of areas used for detecting a telop area and color characteristics;

FIG. 25 is a diagram illustrating an example of combinations of data recording states of a recording medium A and recording formats capable of recording on a recording medium B;

FIG. 26 is a diagram illustrating data attributes in the MPEG format.

FIG. 27A and FIG. 27B are diagrams illustrating examples of the amount of recording data;

FIG. 28A and FIG. 28B are diagrams illustrating examples of recording formats adopted for individual time slots;

FIG. 29 is a diagram illustrating the other examples of recording formats adopted for individual time slots;

FIG. 30 is a diagram illustrating an example of characteristics between recording time and recording capacity;

FIG. 31 is a flowchart illustrating recording processing;

FIG. 32 is a flowchart, subsequent to FIG. 31, illustrating recording processing; and

FIG. 33 is a block diagram illustrating an example of the configuration of a personal computer.

### DETAILED DESCRIPTION

In the following, a description will be given of embodiments of the present invention with reference to the drawings.

Here, consideration will be given to the case where extraction processing of the characteristic of video and audio data (video/audio stream) is performed, the characteristic data is detected from the result of the extraction processing, a predetermined key frame (important point and important position) and a characteristic point are detected on the basis of the detected characteristic data, and operations using the characteristic data such as a digest reproduction (summary reproduction) operation, chapter setting operation, etc., are achieved.

In order to address the above-identified problem, described in “Summary of the Invention” in that it is difficult to ensure consistency of the characteristic points determined on the basis of the characteristic data when the video/audio data of the same contents are captured in different recording formats, the following are considered, for example.

1. A certain baseband of one piece of video/audio data is subjected to characteristic extraction processing to detect the characteristic data. The characteristic data is used in common among the video/audio data (a plurality of pieces of video/audio data obtained when being captured in different recording formats)

2. Any one piece of video/audio data is subjected to characteristic extraction processing among a plurality of pieces of video/audio data having different recording formats in order to detect characteristic data. The characteristic data is used in common among the video/audio data having different recording formats

In this regard, a description will be given of the embodiments of the present invention in the following sequence.

1. About information recording modes

1.1 When two recording formats are used

1.2 When three or more recording formats are used

2. About information reproduction modes

3. About recording modes of characteristic data and special reproduction data

3.1 Characteristic data

3.2 Special reproduction data

3.3 Recording modes
3.3.1 When the contents of video/audio data are the same
3.3.2 When the contents of video/audio data are different

3.4 Other recording modes (when recording on IC memory or IC tag)

4. Operations in reservation recording (reservation recording and timer recording) mode

5. Example of recording configuration

6. Digest reproduction and chapter processing using characteristic data

6.1 Digest reproduction using characteristic data

6.2 Automatic chapter processing using characteristic data

7. overall configuration

7.1 Recording configuration

7.2 Reproduction configuration
7.2.1 Normal reproduction mode operation
7.2.2 Digest reproduction mode and chapter mode
   7.2.2.1 When playlist data and/or chapter data is recorded
   7.2.2.2 When playlist data and/or chapter data is not recorded
      7.2.2.2.1 When characteristic data is recorded
      7.2.2.2.2 When characteristic data is not recorded
         8. Another overall configuration

8.1 Recording configuration

8.2 Reproduction configuration

9. Characteristic extraction processing

9.1 Audio system characteristic extraction processing
9.1.1 Silent characteristic extraction processing
9.1.2 Other audio characteristic extraction processing

9.2 Video system characteristic extraction processing
9.2.1 Scene change characteristic
9.2.2 Color characteristic
9.2.3 Similar scene characteristic
9.2.4 Telop characteristic
   10. Embodiment of when a large-capacity recording medium and another recording medium are used together

10.1 How to determine available recording formats

10.2 Recording methods
10.2.1 When data of both recording format 1 and recording format 2 is recorded on recording medium A
10.2.2 When only data of recording format 1 is recorded on recording medium A
10.2.3 When only data of recording format 2 is recorded on recording medium A
   11. Embodiment of when a plurality of pieces of video/audio data in recording format 1 are recorded in recording format 2

11.1 Setting sequence of operation mode and operation sequence

12. Embodiment of when recording capacity is insufficient

12.1 When disc supporting two-recording format is used
12.2 Changing recording rates
   13 Operation flowchart
   1. About Information Recording Modes

First, a description will be given of data recording modes of a recording medium (optical disc) mounted on the recording/reproducing apparatus according to an embodiment the present invention.

1.1 When Two-Recording Mode is Used

Here, the two-recording mode refers to a recording mode in which data is recorded onto one optical disc (recording medium) in different two recording formats, for example the normal DVD format and the BD format. That is to say, a recording medium used in a recording/reproducing apparatus according to an embodiment of the present invention is provided with a plurality of layers and is capable of recording data on individual layers in different recording formats. Also, the apparatus is capable of reading and reproducing data recorded in different recording formats on the plurality of layers.

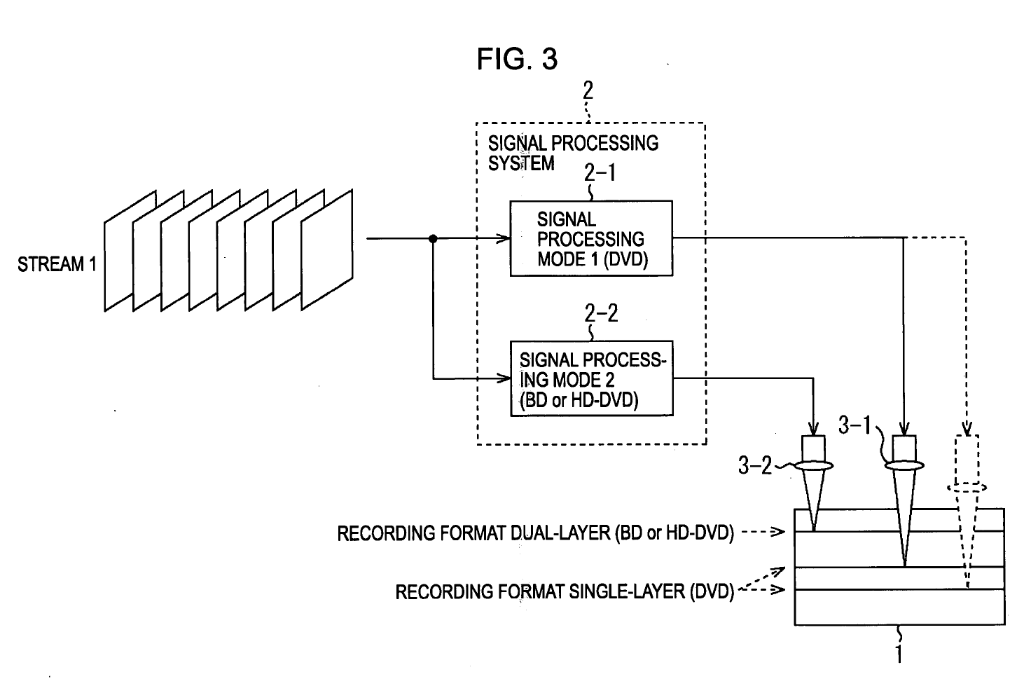

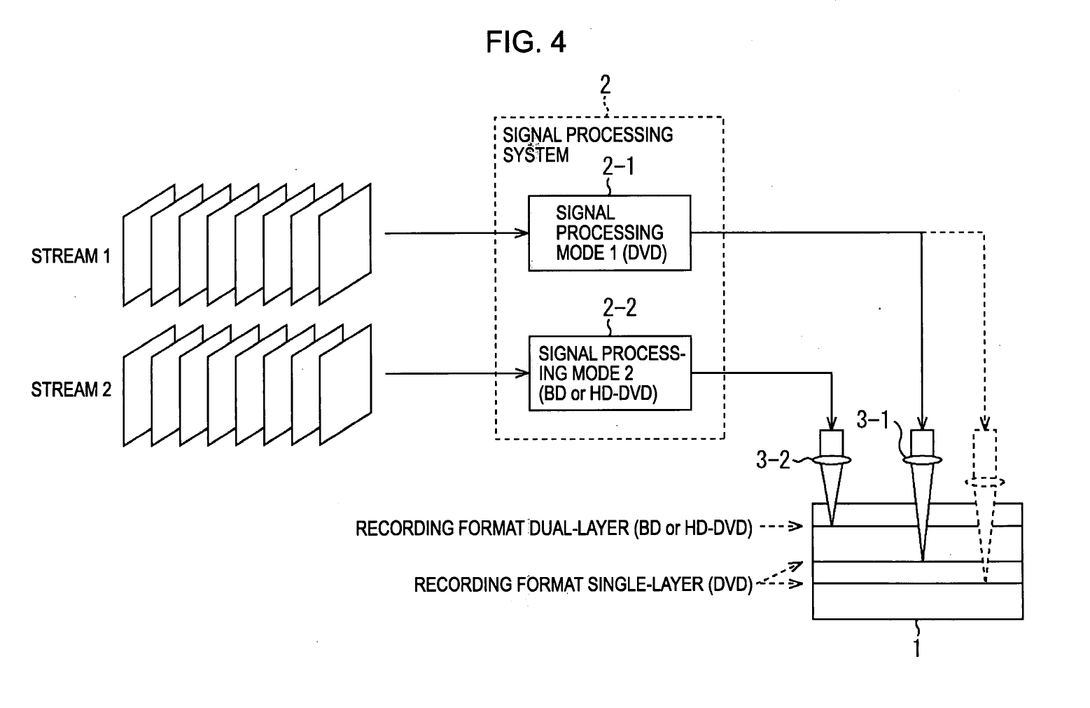

FIGS. 3 and 4 are diagrams illustrating an example of data recording in the two-recording mode.

FIG. 3 illustrates an example of the case in which one stream supplied from the outside is recorded in two different recording formats. FIG. 3 illustrates data recording modes in a recording/reproducing apparatus to which the present invention is applied.

FIG. 4 illustrates an example of the case in which two streams are individually recorded in two different recording formats. FIG. 4 illustrates the example in order to make a comparison with data recording modes in the recording/reproducing apparatus to which the present invention is applied.

The recording medium 1 is provided with a recording format single-layer on which data of the recording format 1 is recorded and a recording format dual-layer on which data of the recording format 2 is recorded. For example, the normal DVD format is employed as the recording format 1, and the BD format (or the HD-DVD format) is employed as the recording format 2. In this case, the comparison between the transfer rates (transmission rates or recording rate) of the recording format 1 and the transfer rate of the recording format 2 shows that the recording format 2 has a higher transfer rate.

As shown in FIG. 3, the stream 1 supplied from the outside is subjected to the signal processing of a signal processing mode 1 in a signal processing system 2-1, and a laser beam corresponding to the processing result data is emitted through a pickup 3-1 to record the stream 1 onto the recording format single-layer of the recording medium 1. Also, the stream 1 is subjected to the signal processing of a signal processing mode 2 in a signal processing system 2-2, and a laser beam corresponding to the processing result data is emitted through a pickup 3-2 to record the stream 1 onto the recording format dual-layer of the recording medium 1.

On the other hand, in an example in FIG. 4, a stream 1 supplied from the outside is subjected to the signal processing of a signal processing mode 1 in a signal processing system 2-1, and then is recorded onto the recording format single-layer of the recording medium 1. Also, a stream 2 which is a different stream from the one supplied to the signal processing system 2-1 is subjected to the signal processing of a signal processing mode 2 in signal processing system 2-2, and then is recorded onto the recording format dual-layer of the recording medium 1.

1.2 When Three or More Recording Formats are Used

In this case, as described above, the recording format 1 can be the normal DVD format, and the recording format 2 can be the BD format (or HD-DVD format) as well. Also, the recording format 3 can be the normal CD format. On the normal CD format, still images, images, etc., are recorded in addition to audio data.

In this case, the recording medium 1 is provided with a layer for recording data in the normal CD format in addition to the recording format single-layer and the recording format dual-layer shown in FIGS. 3 and 4.

In this regard, it is also possible to employ the normal DVD format as the recording format 1, the HD-DVD format as the recording format 2, and the BD format as the recording format 3. Also, when the recording medium is provided with a still larger number of layers, it is possible to employ the normal DVD format as the recording format 1, the HD-DVD format as the recording format 2, the BD format as the recording format 3, and the CD format as the recording format 4, and thus to record data onto individual layers in four different recording formats. In this manner, it is possible to record data onto the recording medium 1 in two or more recording formats.

2. About Information Reproduction Mode

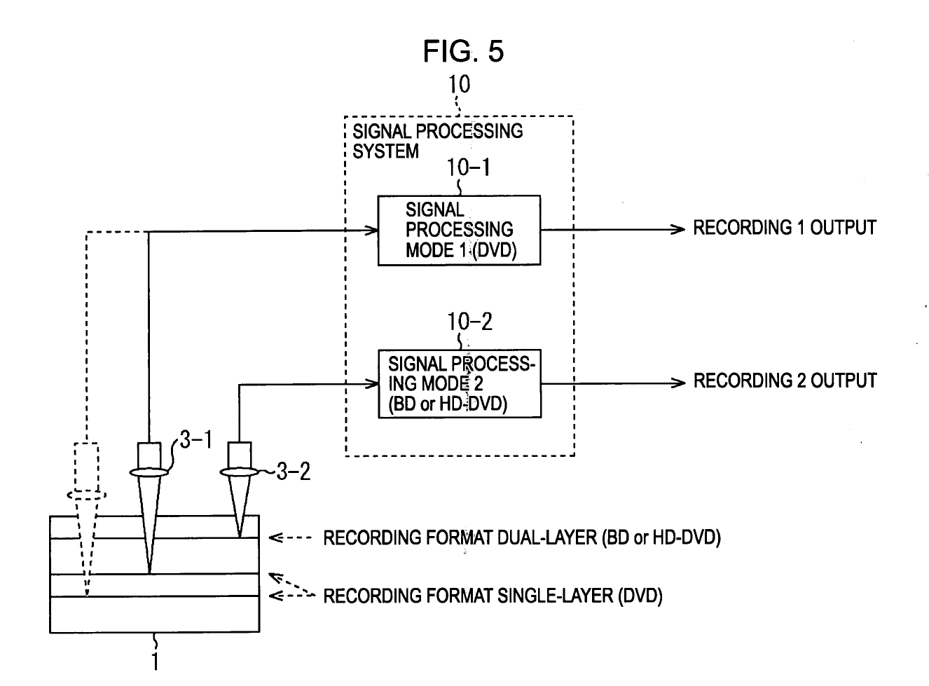

FIG. 5 is a diagram illustrating an example of reproduction of the data recorded onto the recording medium 1 in the two-recording format.

The data recorded in the normal DVD format on the recording format single-layer is read through the pickup 3-1 to be reproduction processed in a signal processing system 10-1. The obtained reproduction signal (video signal and audio signal) is output to the subsequent-stage configuration.

Also, the data recorded in the BD format on the recording format dual-layer is read through the pickup 3-2 to be reproduction processed in a signal processing system 10-2. The obtained reproduction signal (video signal and audio signal) is also output to the subsequent-stage configuration.

In this manner, at least any one of the data recorded in the recording format 1 and the recording format 2 can be selectively reproduced from the recording medium 1.

3. About Recording Modes of Characteristic Data and Special Reproduction Data

First, a description will be given of characteristic data and special reproduction data

3.1 Characteristic Data

The characteristic data is classified into video characteristic data and audio characteristic data. The video characteristic data includes telop characteristic data, color characteristic data, and the other characteristic data. Also, the audio characteristic data includes silent characteristic data.

For example, the telop characteristic data out of the video characteristic data is a pair of the position information of the field (or frame, etc.) in which a telop is displayed and an AC (Alternating current) coefficient data of the DCT (Discrete Cosine Transform) representing the characteristic of the telop. This is the data representing the characteristic and attribute at a certain position in the stream.

In this regard, when a recording start time, a recording start position, etc., are known, or when the position of the characteristic data in the entire stream is known from the order of the characteristic data, the position information of the field may be eliminated, and only the AC coefficient, etc., of the DCT may be recorded as the characteristic data on the recording medium 1. That is to say, in this case, the characteristic data becomes the DCT coefficient data sorted in the sequence of positions on the basis of the recording start position and the DCT coefficient data sorted in time series.

The characteristic data is used for detecting a key frame which is a frame representing an important position in a stream. The position of the key frame is represented by a field number, a frame number, a time period from the recording start point, and the other position information. This position information is generated by the processing described below as playlist data. That is to say, if there is characteristic data, it becomes possible to generate the playlist. The playlist generated on the basis of the characteristic data is appropriately used for digest reproduction and chapter processing.

In this manner, the characteristic data is used for generating a playlist. If a playlist is provided, it becomes possible to perform the digest reproduction and the chapter processing described below. However, the user may modify the playlist data by himself or herself, and thus the characteristic data may be kept in a predetermined recording medium such as the recording medium 1, an internal HDD, or the like along with the playlist data without being deleted after the generation of the playlist.

Also, the recording medium on which the stream to be processed is recorded sometimes does not contain the playlist data of the stream. Thus, the characteristic data may be kept in a predetermined recording medium such as an internal HDD. For example, when the recording medium on which a stream having been reproduced in the past does not contain the playlist data of that stream, if the characteristic data was detected, the playlist data was generated, and was held at the reproduction time in the past, it becomes possible to use the held playlist to perform the digest reproduction, the chapter processing, etc., at the time of reproducing the same stream again.

A description will be given of how to detect the characteristic data later.

3.2 Special Reproduction Data

Special reproduction data includes playlist data and chapter data. For example, the special reproduction data is the position data of the characteristic point (characteristic position) used at the time of special reproduction. The playlist data is generated by the detection processing of the characteristic point based on the characteristic data.

Here, the special reproduction includes reproduction methods other than a normal reproduction in which the entire stream (or a predetermined range of stream) is reproduced in time series, for example digest reproduction in which only characteristic scenes are reproduced among the entire stream, skip reproduction in which predetermined time scenes are reproduced at predetermined intervals, displaying a screen at a predetermined position in the stream as a still image (including thumbnail display), displaying a screen at a position of setting a chapter as a still image (including thumbnail display), and the like.

When only a key-frame section is reproduced in the digest reproduction mode, the start position and the end position of the key-frame section are considered to be individual characteristic points, and the position information thereof is considered to be the playlist data. Also, only the start position of the key-frame section can be considered to the characteristic points.

The processing using this characteristic data is, for example displaying, by thumbnails, the frames at which those characteristic points are set, or the like when scene changes of a broadcasting program are to be viewed or when the outline of the edited and recorded contents is to be obtained.

A characteristic point or a key-frame position may be, for example the position at which a telop is started to be displayed, the start position of scenes similar to a certain scene, the end position of a CM section, and the like.

The start position of the main program after completion of a CM and the end position of the main program before a CM can be obtained from the start position and the end position of the CM. Thus, from another viewpoint, the end position of the main program before a CM (end point) or the start position of the main program after completion of a CM (start point), that is to say, the start position and the end position of the main program can be individual characteristic points.

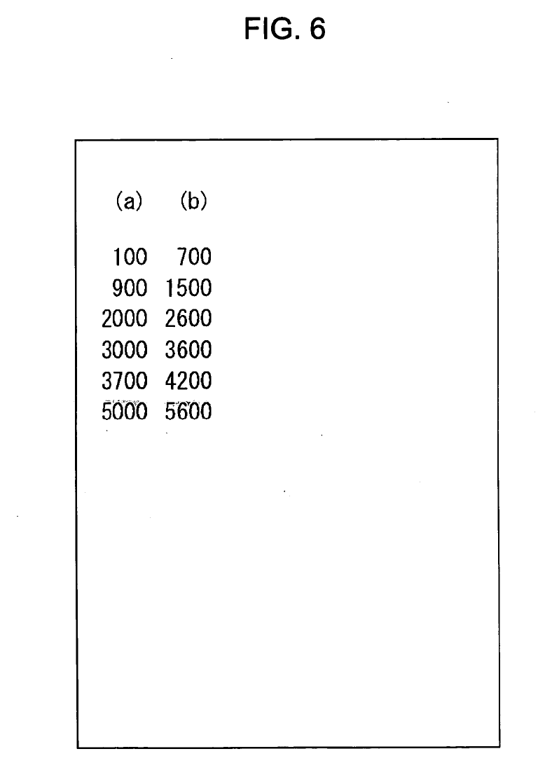

FIG. 6 is a diagram illustrating an example in which playlists are displayed as text data.

Data such as field numbers representing the characteristic-point start position and the characteristic-point end position as shown in FIG. 6 are recorded on a predetermined recording medium such as an HDD and an optical disc as a predetermined file or the data itself.

As a matter of course, for example position information, such as a frame number, time information from the start of recording a program may be recorded as playlist data in place of a field number. Also, only the first position information of the characteristic section shown in the (a) column in FIG. 6 may be recorded as playlist data.

Such playlist data is used in a special reproduction mode, such as skip reproduction, etc., and in a thumbnail display mode of characteristic data, etc.

In FIG. 6, the data in the (a) column is the information indicating the start position of the characteristic section, and the data in the (b) column is the information indicating the end position of the characteristic section. In the example in FIG. 6, the section identified by the first data recorded in the playlist data is the section between 100 and 700 fields, and this section is set to be a characteristic section.

For example, in the digest reproduction mode, only the sections identified by the data in the (a) column and the (b) column in FIG. 6 are reproduced. Thus, the stream is reproduced in a short time compared with the case of reproducing the entire stream in time series. In the case of the example in FIG. 6, the skip reproduction is performed for 100 to 700 fields, 900 to 1500 fields, 2000 to 2600 fields, . . . , 5000 to 5600 fields, and the other sections are not reproduced.

Also, in the thumbnail display mode, the image of the position identified by the data of the (a) column in FIG. 6 is displayed by thumbnails.

3.3 Recording Modes

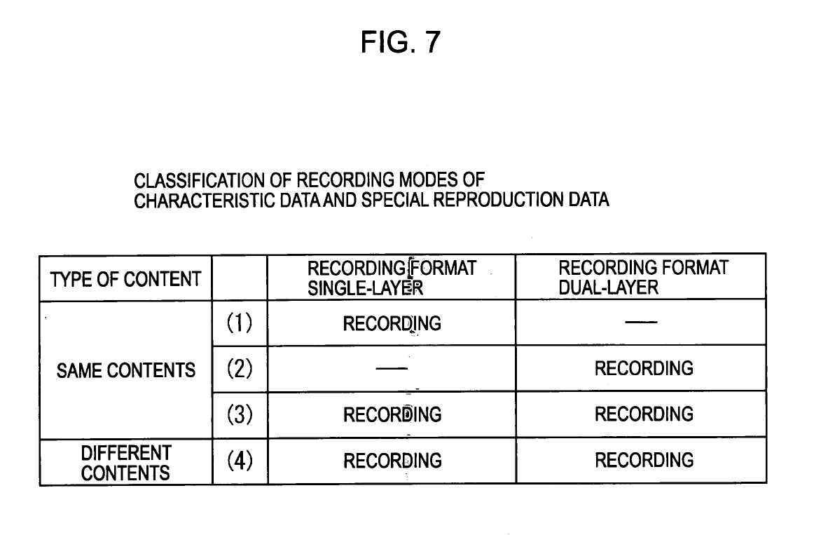

FIG. 7 is a diagram illustrating recording modes of characteristic data and special reproduction data in a recording medium 1 on which two-recording format (recording format 1 and recording format 2) streams are recorded.

As described below, the characteristic data and the special reproduction data may not be recorded onto the recording medium 1 as necessary. Here, the recording format 1 is the normal DVD format, and the recording format 2 is the BD format.

From (1) to (3) in FIG. 7 show the combinations of the case of where the contents of the streams recorded on the recording format single-layer and the recording format dual-layer are the same, whereas (4) shows the combinations of the case where the contents are different.

3.3.1 When the Contents of Video/Audio Data are the Same

As shown by (1) in FIG. 7, the characteristic data and the special reproduction data are recorded on the recording format single-layer, whereas no data is recorded onto the recording format dual-layer.

An apparatus having a function of reproducing the BD format data or the HD-DVD format data is generally capable of reproducing a larger amount of data compared with an apparatus having only the function of reproducing the normal DVD format data, is considered to have a higher performance, and a higher cost. Thus, the apparatus having a function of reproducing the BD format data or the HD-DVD format data is often provided with the function of recording/reproducing the normal DVD format data additionally. In the case of such an apparatus, the combination of (1) in FIG. 7 is considered to be one of the effective recording modes.

Also, as shown by (2) in FIG. 7, the characteristic data and the special reproduction data may not be recorded on the recording format single-layer, and the characteristic data and the special reproduction data may be recorded on the recording format dual-layer.

Furthermore, as shown by (3) in FIG. 7, the characteristic data and the special reproduction data may be recorded on both the recording format single-layer and the recording format dual-layer. In the case of this combination, an apparatus having only one of the reproduction functions of the recording formats may handle the recording medium.

In this regard, when the same stream is individually recorded in the two recording formats, that is to say, when the recorded content of a movie or a program is the same and as shown by (3) in FIG. 7, and the characteristic data and the special reproduction data are recorded on both the recording format single-layer and the recording format dual-layer, the characteristic points are set at the position (the position of the same scene) corresponding to the individual streams. It is preferable that consistency is ensured between the reproduction section of the digest reproduction carried out based on the characteristic point when the stream of one of the recording formats is reproduced and when the stream of the other of the recording formats is reproduced.

For example, although the content is the same, if the reproduction content of when the stream of one of the recording formats is digest reproduced is different from that of when the stream of the other of the recording formats is digest reproduced, the user feels uncomfortable.

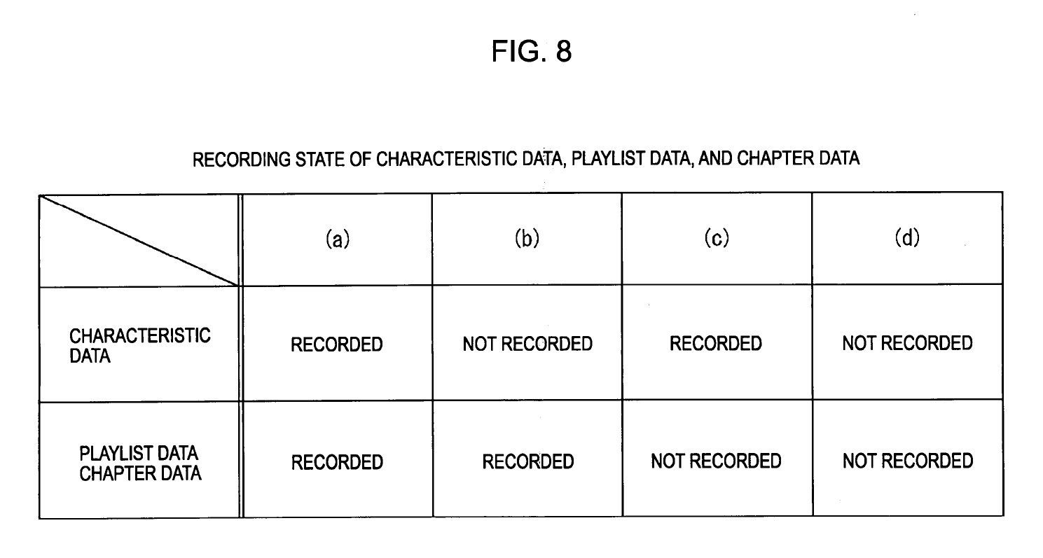

FIG. 8 is a diagram illustrating an example of recording states of characteristic data and playlist data.

As shown by (a) in FIG. 8, the characteristic data and the playlist data (and chapter data described below) may be recorded on recording medium 1. Alternatively, as shown by (b) in FIG. 8, the characteristic data may not be recorded and only the playlist data may be recorded on recording medium 1. Also, as shown by (c) in FIG. 8, only the characteristic data may be recorded on recording medium 1 and the playlist data may not be recorded.

Furthermore, as shown by (d) in FIG. 8, the characteristic data and the playlist data may not be recorded on recording medium 1. In the case of the combination of (d) in FIG. 8, it is difficult to perform special reproduction on the stream recorded on the recording medium 1 in this state, and thus the extraction processing of the characteristic as described below and the creation processing of the playlist data are performed as necessary. The special reproduction is performed on the basis of the result.

3.3.2 When the Contents of Video/Audio Data are Different

In this case, as shown by (4) in FIG. 7, in the same manner as the combination of (3) in FIG. 7, which is the case of the same content of stream, it is possible to record the characteristic data and the playlist data on both the recording format single-layer and the recording format dual-layer.

3.4 Other Recording Modes (when Recording on IC Memory or IC Tag)

Other than recording on a predetermined area of the recording format single-layer and the recording format dual-layer of the recording medium 1 as described above, the recording modes of the characteristic data and the playlist data can be considered as follows.

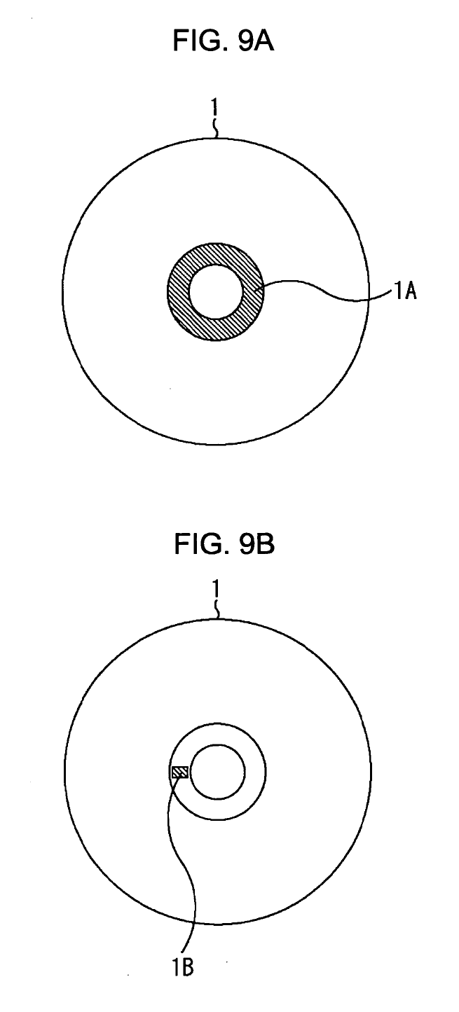

FIGS. 9A and 9B are top views (seen from the vertical direction to the surface of the recording medium 1) of the recording medium 1.

FIG. 9A shows an example of the case where the characteristic data and the playlist data are recorded on an inner circumferential area 1A which is an area different from the normal recording area (for example, a recording area recommended by the format) of the recording medium 1. Of course, the data may be recorded in the outer circumferential area.

FIG. 9B shows an example of the case where an IC memory 1B is embedded at a certain position of the inner circumference of the recording medium 1, and the characteristic data and the playlist data are recorded on the memory. The IC memory 1B may be embedded at the outer circumference of the recording medium 1. For example, the IC memory 1B is provided on the recording medium 1 by inserting an IC pattern into a predetermined layer in the process of producing the recording medium 1.

In this regard, an IC tag may be used in place of the IC memory 1B. In this case, the recording/reproducing apparatus of the recording medium 1 is provided with a reader/writer capable of writing data to the IC tag disposed on the recording medium 1 by wireless communication and reading data recorded on the IC tag by wireless communication.

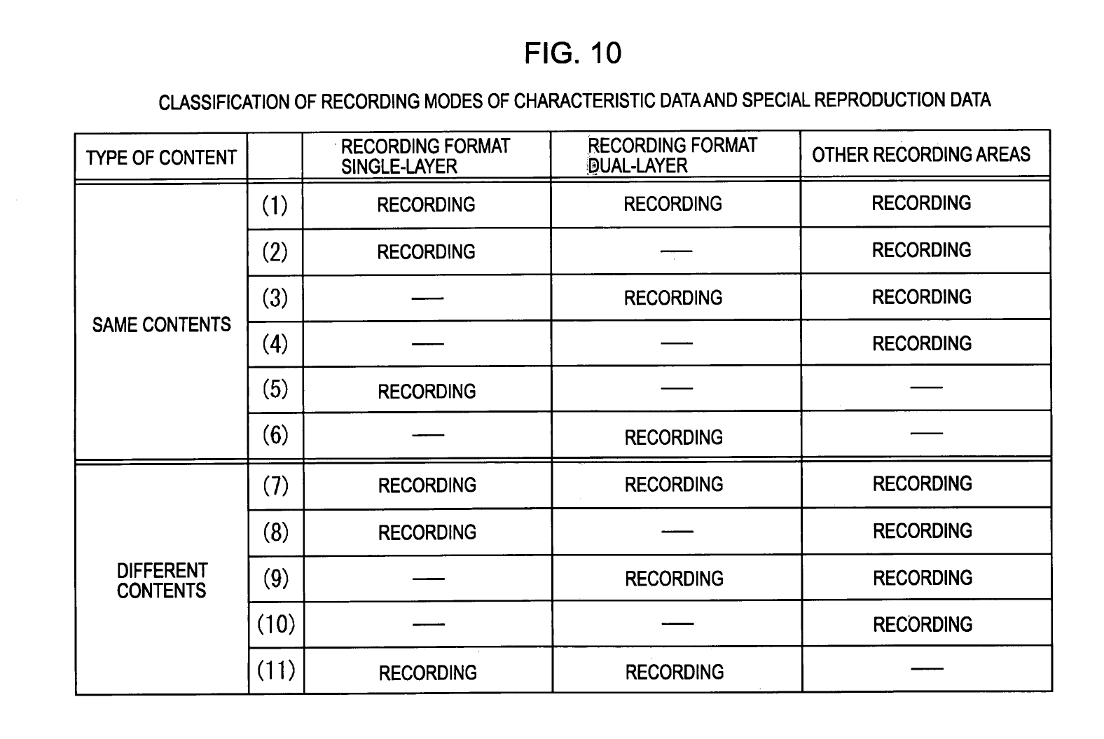

FIG. 10 is a diagram showing the recording modes of the characteristic data and the special reproduction data in the case where another recording area (inner area 1A or IC memory 1B) for the characteristic data and the special reproduction data as shown in FIGS. 9A and 9B is provided in addition to the recording format single-layer and the recording format dual-layer.

From (1) to (6) in FIG. 10 show the combinations of the case where the contents of the streams recorded on the recording format single-layer and the recording format dual-layer are the same, whereas from (7) to (11) in FIG. 10 show the combinations of the case where the contents are different.

4. Operations in Reservation Recording (Reservation Recording and Timer Recording) Mode

Here, a description will be given of the operation of the recording/reproducing apparatus at the time of the reservation recording of a long program in accordance with the setting of the user. Assuming that the user wants to view the recorded stream as high image-quality as possible, the stream is recorded in the recording mode of the recording format 2, which records with high quality as much as possible by the default setting (initial setting).

While a high-quality high-definition television program is recorded on a recording area of the recording format dual-layer in the recording format 2, which is a high-quality recording mode, if it is automatically detected that the recording capacity of the recording format dual-layer currently being used becomes insufficient in order to record the entire program, or if it is automatically detected that the recording capacity becomes insufficient soon, the recording mode is changed to another format, for example to the recording format 1, depending on the apparatus, and then the subsequent data is recorded.

At this time, predetermined information indicating that the recording format has been changed and the same program has been recorded on another recording layer continuously is recorded on the recording format single-layer, which is the destination recording layer, or the recording format dual-layer, which is the source recording layer.

In this regard, the user may be allowed to change the setting of the recording mode. For example, the user is allowed to change the default setting from the recording in the recording format 2 (the BD format or the HD-DVD format) to the recording in the recording format 1 (the normal DVD format).

5. Example of Recording Configuration

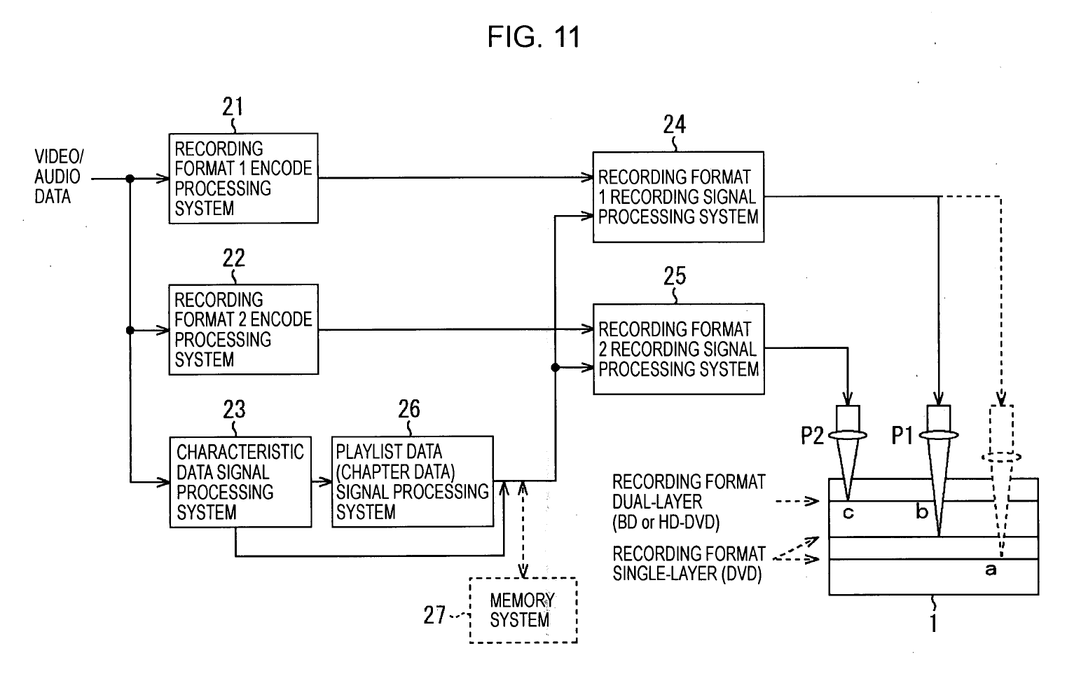

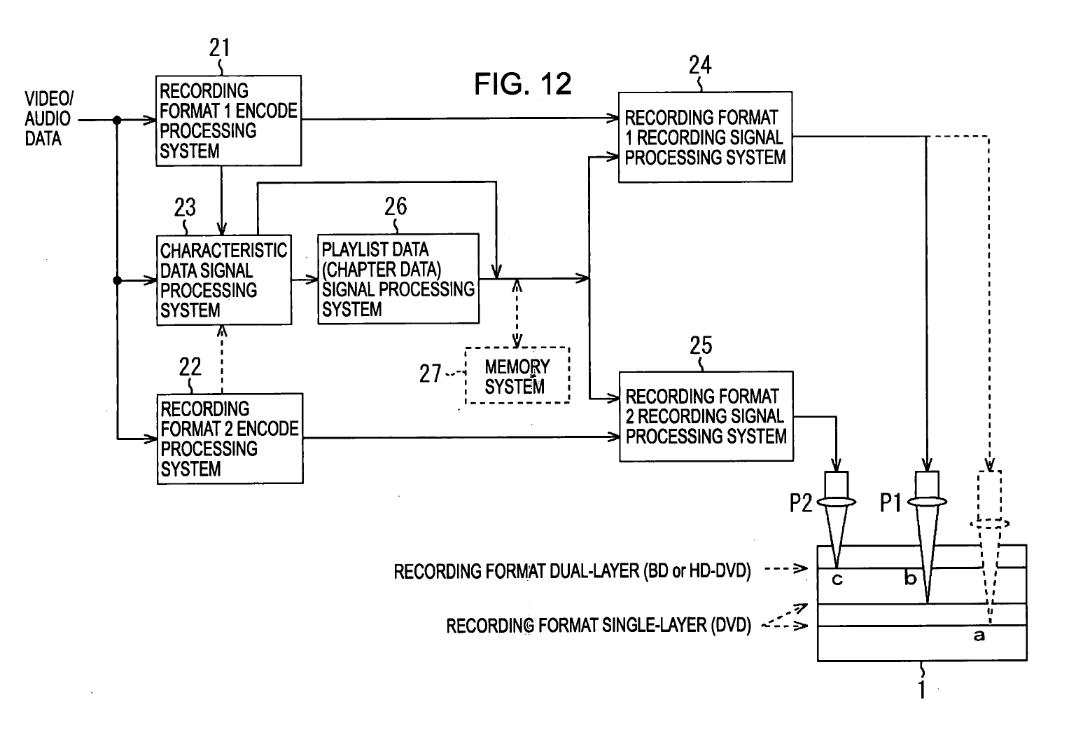

FIGS. 11 and 12 are block diagrams illustrating examples of the configuration of a recording side for recording a same content on the recording medium 1 in a plurality of recording formats.

FIG. 11 illustrates the configuration for extracting the characteristic directly from the input stream (video/audio data) and recording the characteristic data representing the extracted characteristic on the recording medium 1.

The input stream to the recording/reproducing apparatus is supplied to the recording format 1 encode processing system 21 and the recording format 2 encode processing system 22, and is subjected to the encode processing in accordance with the recording formats, respectively. The encode result in the recording format 1 encode processing system 21 is output to a recording format 1 recording signal processing system 24, and the encode result by the recording format 2 encode processing system 22 is output to a recording format 2 recording signal processing system 25.

Also, the input stream to the recording/reproducing apparatus is supplied to a characteristic-data signal processing system 23. In the characteristic data signal processing system 23, video characteristic data is extracted by predetermined video characteristic extraction processing, and audio characteristic data is extracted by predetermined audio characteristic extraction processing. When playlist data and chapter data, in addition to the characteristic data, is to be recorded on the recording medium 1 (for example, when obtaining the recording medium 1 by recording data by the combination of (a) in FIG. 8), the detected characteristic data is output to the playlist data (chapter data) signal processing system 26. When only the characteristic data is to be recorded on the recording medium 1 and the playlist data, and the chapter data is not recorded (for example, when obtaining the recording medium 1 by recording data by the combination of (c) in FIG. 8), the detected characteristic data is output to both of the recording format 1 recording signal processing system 24 and the recording format 2 recording signal processing system 25.

In the recording format 1 recording signal processing system 24, the normal DVD recording processing, which records the normal DVD data supplied from the recording format 1 encode processing system 21 on the recording format single-layer (layer a or layer b in the figure), and the processing, which records the data supplied from the characteristic data signal processing system 23 and the playlist data (chapter data) signal processing system 26 on predetermined recording layer (position) by the combination in FIGS. 7 and 10, are performed.

In this regard, in FIG. 11, a layer a is provided when the recording format single-layer of the recording medium 1 supports the DVD DL (Dual Layer). This is also the same in FIG. 12 described below, and the like.

In the recording format 2 recording signal processing system 25, the recording processing, which records the BD format data or the HD-DVD format data supplied from the recording format 2 encode processing system 22 on the recording format dual-layer, and the processing, which records the data supplied from the characteristic data signal processing system 23 and the playlist data (chapter data) signal processing system 26 on a predetermined recording layer (position) by the combination in FIGS. 7 and 10, are performed.

A memory system 27 indicated by the dotted line in FIG. 11 is used for temporarily storing the data obtained by the characteristic data signal processing system 23 when, for example it is difficult for the recording format 1 recording signal processing system 24 to simultaneously record the data supplied from the recording format 1 encode processing system 21 and the characteristic data obtained by the characteristic data signal processing system 23 (or the playlist data and the chapter data obtained by the playlist data (chapter data) signal processing system 26) on the recording medium 1.

For example, although simultaneous recording is, not allowed, when the characteristic data and the playlist data, etc., are recorded on individual recording layers, respectively as shown by (3) in FIG. 7, the data obtained by the characteristic data signal processing system 23 or the playlist data (chapter data) signal processing system 26 is temporarily stored into the memory system 27, and is read at recordable timing.

The processing is not performed such that the characteristic data obtained from the encoding result by the recording format 1 encode processing system 21 is set to be the characteristic data of the recording format 1 data, and the characteristic data obtained from the encoding result by the recording format 2 encode processing system 22 is set to be the characteristic data of the recording format 2 data. As described above, the characteristic data obtained from one stream and the playlist data obtained therefrom is recorded onto the recording medium 1 as the common characteristic data and playlist data of the recording format 1 and recording format 2, and thus it is possible to prevent from losing consistency between the characteristic data of the recording format 1 and the characteristic data of the recording format 2.

That is to say, the thumbnail display and the special reproduction are performed on the basis of the common characteristic data and the playlist data obtained therefrom. Thus, it is possible to prevent the selection position of the thumbnail image and the reproduction position at special reproduction time in the stream from being different between the case where the recording format 1 data is processed and the case where the recording format 2 data is processed, and to prevent from giving uncomfortable feeling to the user.

FIG. 12 shows the configuration in which characteristic is extracted from the data obtained in the process of the processing performed at least in either the recording format 1 encode processing system 21 or the recording format 2 encode processing system 22, and the characteristic data representing the extracted characteristic is recorded on the recording medium 1 as the common characteristic data to the recording format 1 data and the recording format 2 data. The parts corresponding to those in FIG. 11 are marked with the same reference numerals.

For example, when the MPEG format is used for an encoding format, the data (the data obtained in the process of processing) used for the characteristic extraction includes an AC coefficient, a DC coefficient, etc., obtained in the DCT processing.

When the encoding result by the recording format 1 encode processing system 21 is used for the data for extracting the characteristic, and the characteristic data representing the extracted characteristic or the special reproduction data such as the playlist data obtained therefrom are used for the common characteristic data and the special reproduction data of the stream of the recording format 1 and recording format 2, the encoding result by the recording format 1 encode processing system 21 is also supplied to the characteristic data signal processing system 23.

In the characteristic data signal processing system 23, the characteristic extraction processing is performed, the obtained characteristic data is supplied to the recording format 1 recording signal processing system 24 and the recording format 2 recording signal processing system 25, and then is recorded on a predetermined recording position of the recording medium 1. Also, the characteristic data is supplied to the playlist data (chapter data) signal processing system 26 as necessary. In the playlist data (chapter data) signal processing system 26, generation processing of the playlist data, etc., based on the characteristic data obtained by the characteristic data signal processing system 23, the obtained playlist data is supplied to the recording format 1 recording signal processing system 24 and the recording format 2 recording signal processing system 25, and is recorded at a predetermined recording position.

As described above, when simultaneous recording is not allowed on a plurality of recording layers, the characteristic data obtained by the characteristic data signal processing system 23 (or the playlist data and the chapter data obtained by the playlist data (chapter data) signal processing system 26) is temporarily recorded on the memory system 27 as necessary, and is read at a predetermined timing to be recorded at a predetermined recording position of the recording medium 1.

In this regard, when the encoding result by the recording format 2 encode processing system 22 is used as the data for extracting a characteristic in place of the encoding result by the recording format 1 encode processing system 21, the characteristic data representing the extracted characteristic, or the special reproduction data such as the playlist data obtained therefrom are used for the common characteristic data and the special reproduction data of the stream of the recording format 1 and the recording format 2, the encoding result by the recording format 2 encode processing system 22 is also supplied to the characteristic data signal processing system 23 as shown by the dotted line in FIG. 12, and subsequently, the same processing is performed in each system in the same manner as the case of using the encoding result by the recording format 1 encode processing system 21 as described above.

In this manner, it is possible to prevent losing consistency between the characteristic data of the recording format 1 and the characteristic data of the recording format 2 by using the characteristic data obtained from either one of the encode results (or the data obtained in the process of encode processing) out of the recording format 1 and the recording format 2 or the playlist data obtained therefrom as the common characteristic data between the recording formats 1 and 2.

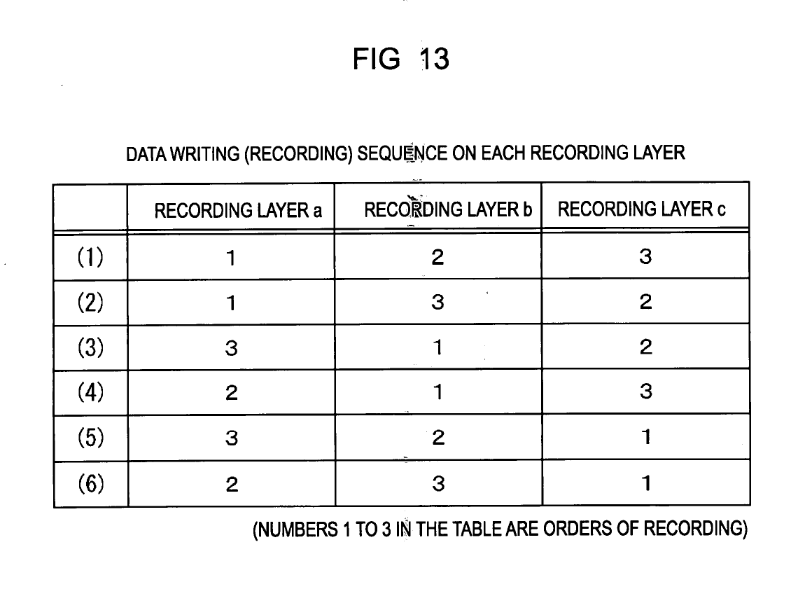

Here, the data recording sequence in the configuration shown in FIG. 11 or FIG. 12 is shown in FIG. 13.

As shown by (1) to (6) in FIG. 13 individually, the stream, the characteristic data, etc., can be recorded in the sequence: the recording layer a→the recording layer b<the recording layer c, the recording layer a→the recording layer c→the recording layer b, the recording layer b→the recording layer c→the recording layer a, the recording layer b→the recording layer a→the recording layer c, the recording layer c→the recording layer b→the recording layer a, and the recording layer c→the recording layer a→the recording layer b.

In this regard, individual data may be recorded by the simultaneous recording on the three layers: the recording layers a, b, and c, or by the simultaneous dual-layer recording on any two of the layers.

6. Digest Reproduction and Chapter Processing Using Characteristic Data

A detailed description will be given of the signal processing related to the following general operations in the below items appropriately in addition to the items here.

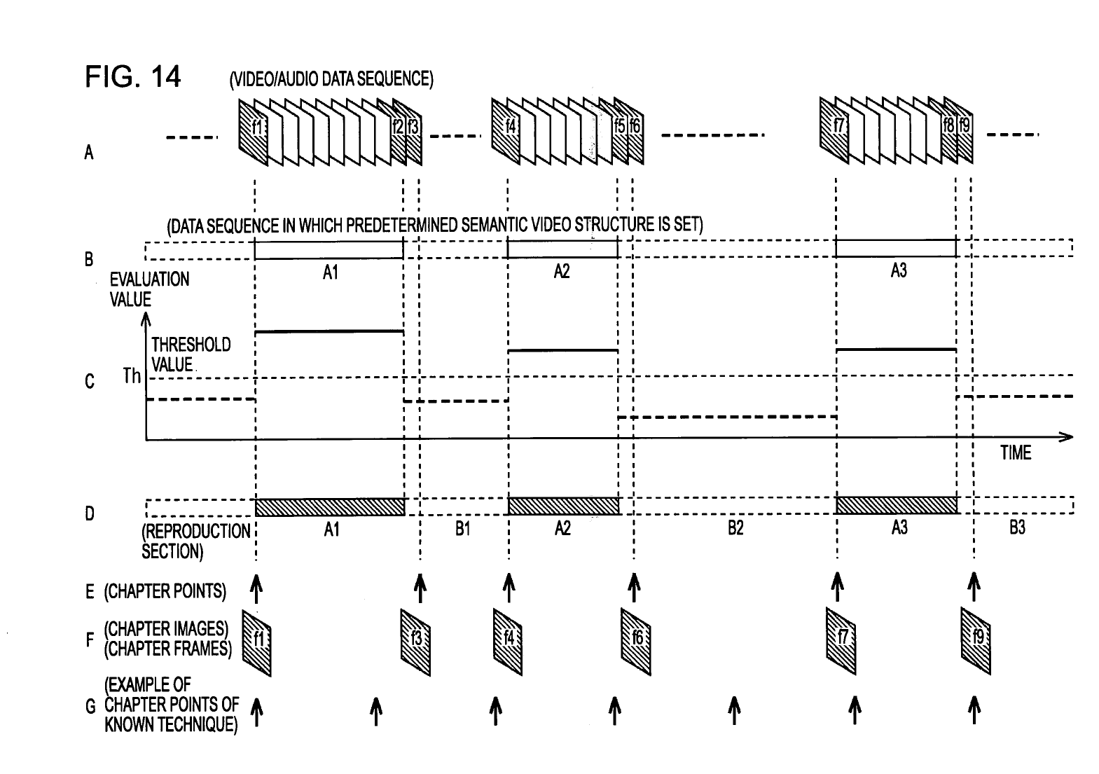

FIG. 14, A to G, is a diagram illustrating the digest reproduction and the chapter processing using the characteristic data. First, a description will be given of the digest reproduction using the characteristic data.

6.1 Digest Reproduction Using Characteristic Data

Here, suppose that there is a video/audio data sequence as shown by FIG. 14, A. This video/audio data sequence is a broadcasting program, movie software, and another content. The video/audio data sequence is read from a predetermined recording medium, such as a hard disk (HDD), a magneto-optical disc, a large-capacity semiconductor memory, etc., and is used for reproduction processing.

The digest reproduction using the characteristic data includes:

(a) A method of skip reproducing between the characteristic points (characteristic position)

(b) A method of reproducing a characteristic point section

(c) A method of assuming a predetermined semantic structure section based on the characteristic data, and reproducing based on the semantic structure section.

The above-described method (a) is a method in which, for example the start position and the end position of a television CM are detected, the start position and the end position of the main program obtained from the detected start position and end position of the television CM are set to be the characteristic points, and only the main program section is reproduced. When television CMs broadcasting in Japan are considered, there is a characteristic in which silent sections can be detected for each integer multiple of 15 seconds. Thus, the start positions and the end positions of television CMs are detected on the basis of that characteristic.

The method (b) is a method in which, for example the sections of displaying telops are reproduced. In news programs, etc., telops are often displayed in important parts. Thus, it is possible to reproduce only the parts that are considered to be important.

The method (c) is a method in which, for example “a section of while an announcer is reading news” is detected as a semantic structure of a news program. When all the news programs are concerned, it can be assumed that there are many scenes in which an announcer appears, that is to say, it is the scene having a high frequency of appearance (condition 1) when individual images are classified for each similar scene. Also, it is assumed to be a section of a speaker's voice (condition 2), and to include a telop display (condition 3) because of a news program. Thus, it is possible to detect a semantic structure section of “a section of while an announcer is reading news” by detecting the sections satisfying these three conditions.

In this regard, when the detection processing of such a semantic section is considered, there are cases where all of the three conditions are not satisfied.

Accordingly, a concept of an evaluation value (score) may be used in the detection processing. For example, the maximum of the evaluation value (a value indicating the degree of satisfying the conditions) is set to 100. Predetermined evaluation value setting processing may be performed such that if all the above-described three conditions are met, the evaluation value is full points (100), if only two conditions are met; the evaluation value is 70, and if only one condition is met, the evaluation value is 30. The sections having evaluation values higher than a threshold value may be selected as a semantic section, and only those sections may be reproduced.

In this regard, the method of setting the evaluation value is not limited to this. Each condition may be weighted in accordance with the characteristic data, and the setting may be carried out on the basis of whether the condition is met. For example, different evaluation values may be set in accordance with the satisfied conditions, for example if the above-described condition 1 (scene having a highest frequency of appearance) is met, the evaluation value may be set to 50, if the condition 2 (a section of a speaker's voice) is met, the evaluation value is set to 20, and if the condition 3 (a section of a telop display) is met, the evaluation value is set to 30. Thus, the semantic section may be selected depending on whether the evaluation value set is over a threshold value. When the threshold value is set to 80, at least the sections satisfying the two conditions, the condition 1 and the condition 2, are selected as the semantic section.

FIG. 14, B shows an example of sections produced by setting a predetermined meaning and dividing the video/audio data sequence of FIG. 14, A into predetermined video structures (semantic video structures) in accordance with scene changes, audio segments, etc.

Here, as shown in FIG. 14, C, a predetermined evaluation value is set for each section of FIG. 14, B (for each section such as a section recorded in a predetermined time period or a predetermined program section, etc.). This evaluation value is set such that a higher evaluation value (evaluation data) is set to a more important section among the entire section, for example a section including a key-frame section.

That is to say, by reproducing only a section to which high evaluation data is set and by the section including a key-frame section, the user can grasp the outline of a program without reproducing the overall sections.

FIG. 14, D is a diagram illustrating an example of the reproduction section based on the evaluation value.

In this example, each section of the frames f1 to f2, f4 to f5, and f7 to f8 of the video/audio data sequence shown in FIG. 14, A is a section having an electronic value for the section higher than a threshold value Th. In this case, as shown by FIG. 14, D, each of the sections, A1, A2, and A3 is skip reproduced, and thus digest reproduction is achieved.

6.2 Automatic Chapter Processing Using Characteristic Data

FIG. 14, E is a diagram, illustrating setting positions of chapter points.

For example, chapter points are set at the beginning of or in the vicinity of predetermined key frames, and at the beginning of or in the vicinity of sections which are not key frame sections and are subsequent to (connecting to) the end of the key frame sections.

FIG. 14, F is a diagram illustrating an example of frames in which a chapter point is automatically set.

In an example of FIG. 14, F, the chapter frames f1, f4, and f7 are the frames at the beginning (or the vicinity) of the key frame sections A1, A2, and A3, respectively. Also, the chapter frames f3, f6, and f9 are the frames at the beginning (or the vicinity) of the sections B1, B2, and B3, which are not key frame sections and are subsequent to the key frame sections A1, A2, and A3, respectively.

A breakpoint, which is set by a so-called automatic chapter setting function of a known DVD recording/reproducing apparatus, is used when that point is used for an indication of edit operation and when fast-forward reproduction (FF reproduction) or fast-backward reproduction (rewind reproduction or REW reproduction) is performed. For example, in a known automatic chapter setting function, chapters are set at predetermined intervals, for example at 5-minute intervals, 10-minute intervals, or 15-minute intervals. As shown in FIG. 14, G, it is sometimes difficult to set a chapter point at the start point of the position which is likely to be a key frame by such chapter setting processing.

Also, a known DVD recording/reproducing apparatus has a function called manual chapter processing, which is capable of setting a chapter point at any point where the user himself/herself wants. However, chapter points are set by actually viewing recorded or recording programs, and thus this is a troublesome operation for the user and not efficient.

However, in the chapter setting processing using characteristic data as in the recording/reproducing apparatus to which the present invention is applied, as shown in FIG. 14, E, chapter points can be appropriately and automatically set at the beginning of or in the vicinity of key frame sections, and at the beginning of or in the vicinity of sections which are not key frame sections and are connecting (or subsequent) to the end of the key frame sections. Thus, compared to the known chapter processing, it becomes possible to set chapter points more effectively (effectively for editing and digest reproduction).

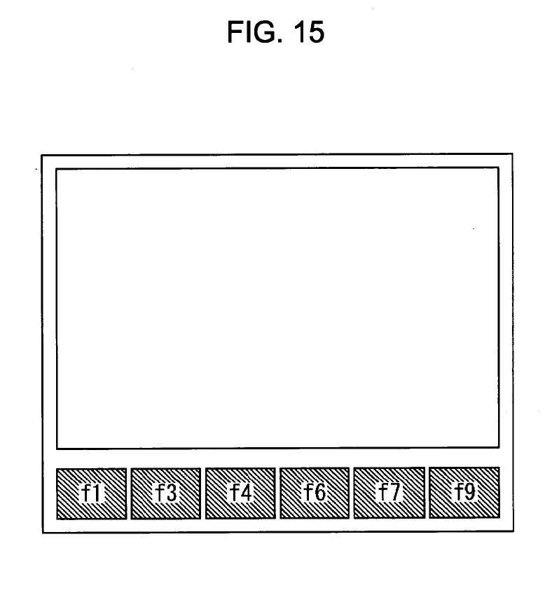

FIG. 15 is a diagram illustrating an example of the display of frames (chapter frames) in which chapter points are automatically set.

In the example of FIG. 15, the chapter images f1, f3, f4, f6, f7, and f9 selected on the basis of the chapter points set in the positions as shown in FIG. 14, E are displayed in the lower part of the screen by the thumbnails.

By viewing the screen as shown in FIG. 15, for example the user can cut out the key-frame sections A1, A2, and A3 in FIG. 14, D from the broadcasting programs recorded on the hard disk, which is an internal recording medium of the recording/reproducing apparatus, and record the data of the sections on a disc recording medium such as a recording medium 1. Alternatively, the user can perform the skip reproduction of only the subsequent predetermined section from the chapter images f1, f4, and f7.

7. Overall Configuration

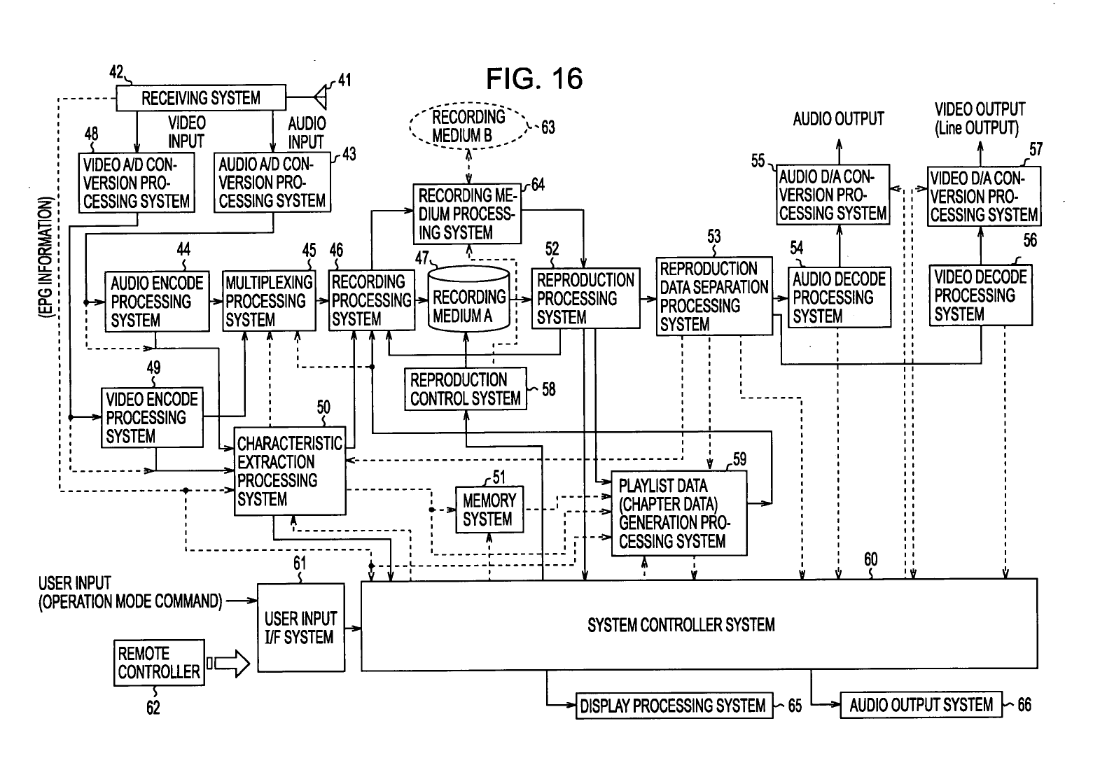

FIG. 16 is a block diagram illustrating an example of the configuration of the entire recording/reproducing apparatus including the configuration of the recording side in FIG. 11 or FIG. 12.

Here, suppose that the video/audio data to be recorded is broadcasting program data, and the broadcasting program data has been subjected to compression processing conforming to MPEG (Moving Picture Exports Group). In this regard, it is possible to use wavelet transformation, fractal analysis processing, etc. For example, in the description described below, the DCT coefficient of image data corresponds to an analysis coefficient in multiple resolution analysis, etc., in the case of wavelet transformation, and the same signal processing is considered to be performed.

In this regard, in FIG. 16, one configuration including both an audio encode processing system 44 and a video encode processing system 49 individually corresponds to the recording format 1 encode processing system 21 and the recording format 2 encode processing system 22 in FIG. 11. A recording processing system 46 individually corresponds to the recording format 1 recording signal processing system 24 and the recording format 2 recording signal processing system 25. Also, a characteristic extraction processing system 50 corresponds to the characteristic data signal processing system 23 in FIG. 11, a memory system 51 corresponds to the memory system 27 in FIG. 11, and a playlist data (chapter data) signal processing system 59 corresponds to the playlist data (chapter data) signal processing system 26 in FIG. 11. Furthermore, a recording medium 63 (recording medium B) corresponds to the above-described recording medium 1. A recording medium 47 (recording medium A) is an internal HDD, for example.

7.1 Recording Configuration

A predetermined broadcasting program is received by a receiving antenna system 41 and a receiving system 42. An audio signal is subjected to A/D conversion processing by an audio A/D conversion processing system 43 with a predetermined sampling frequency and a predetermined number of quantifying bits. The obtained audio data is input into the audio encode processing system 44.

The audio encode processing system 44 performs signal processing by a predetermined band compression method such as, for example MPEG audio, AC3 audio (Dolby AC3 or Audio Code number 3), etc.

Similarly, the video signal of the received broadcasting program is subjected to A/D conversion processing by a video A/D conversion processing system 48 with a predetermined sampling frequency and a predetermined number of quantifying bits. The obtained video data is input into the video encode processing system 49.

The video encode processing system 49 performs signal processing by a predetermined band compression method such as MPEG video, wavelet transformation, etc.

In order to extract characteristics of the audio signal, a part of the signal input from the audio A/D conversion processing system 43 into the audio encode processing system 44, or the signal obtained in the process of the encode processing by the audio encode processing system 44 is appropriately input into the characteristic extraction processing system 50.

Similarly, in order to extract characteristics of the video signal, a part of the signal input, from the video A/D conversion processing system 48 into the video encode processing system 49, or the signal obtained in the process of the encode processing by the video encode processing system 49 is appropriately input into the characteristic extraction processing system 50.

The characteristic extraction processing system 50 performs, for example, the extraction of the characteristic data for each predetermined section in sequence at the time of recording a broadcasting program. The extracted characteristic data is recorded in a predetermined recording area of the recording medium A along with the video/audio data having been subjected to predetermined encode processing. Also, the characteristic data created by the characteristic extraction processing system 50 is supplied to the playlist data (chapter data) signal processing system 59 through a system controller system 60.

The playlist data (chapter data) signal processing system 59 generates playlist data or chapter data from the characteristic data for reproducing the digest.

Here, a description will be given of the signal processing process of the playlist data or the chapter data, which is performed by the playlist data (chapter data) signal processing system 59. The signal processing process is considered to include the following.

a. After a predetermined amount of the characteristic data is stored in the memory system 51 or the memory area of the system controller system 60, the generation processing of the playlist data or the chapter data is performed on the basis of the stored characteristic data.

b. The characteristic data obtained for each characteristic extraction processing is sequentially recorded on the recording medium A along with the video/audio data, and after a predetermined amount is recorded, the characteristic data recorded on the recording medium A is read (reproduced) to perform the generation processing of the playlist data or the chapter data on the basis of the read characteristic data.

In the case of the above-described a, for example, when a broadcasting program having a predetermined time period t is considered, at the point in time when the time t has passed from the start of the recording of the broadcasting program, all the characteristic data is accumulated. Thus, at this time, it is possible to perform the generation processing of the playlist data, which determines where the key frame corresponding to digest reproduction time td is positioned. That is to say, the characteristic data obtained at the time t is stored in the memory system 51 or the memory area of the system controller system 60.

On the other hand, in the case of the above-described b, the characteristic data is recorded onto the recording medium A while the time t passes from the start of the recording of the broadcasting program in the same manner as the case of above-described a. When it is detected that the time t has passed, the characteristic data that has been recorded onto the recording medium A so far is read, and the generation processing of the playlist data in accordance with the digest reproduction time td is started.

When the generation processing of the playlist data has been completed, the preparation for the digest reproduction is completed.

The playlist data generated as described above is supplied to the recording processing system 46, is subjected to predetermined processing, and then recorded on a predetermined recording area of the recording medium A.

Here, as described with reference to FIG. 6, the playlist data is, for example a pair of data of the reproduction start frame number and the reproduction end frame number of each section. The playlist data is used for achieving digest reproduction by skip reproducing only a predetermined section out of the entire recorded video/audio data (program), and thus may be represented by a time code and a time stamp such as PTS (Presentation Time Stamp), DTS (Decode Time Stamp), etc., in MPEG in addition to such frame number data.

7.2 Reproduction Configuration

7.2.1 Normal Reproduction Mode Operation

First, a description will be given of the operation of when a normal reproduction mode is set. When the mode of the recording/reproducing apparatus is set to the normal reproduction mode by the output from the user input I/F system 61, for example predetermined video/audio data, characteristic data, etc., are read from the recording medium A, are supplied to a reproduction processing system 52, and are subject to predetermined reproduction processing. The data obtained from the reproduction processing is output to a reproduction data separation processing system 53.

The reproduction data separation processing system 53 performs the separation processing of the video/audio data into the video data and the audio data, and outputs the audio data and the video data obtained by the processing to an audio decode processing system 54 and a video decode processing system 56, respectively.

The audio decode processing system 54 performs predetermined decode processing corresponding to the signal processing method by which band compression processing has been performed at recording time on the audio data supplied from the reproduction data separation processing system 53. The decoded result is subjected to D/A conversion processing by an audio D/A conversion processing system 55, and the obtained audio signal is output to the outside.

Similarly, video decode processing system 56 performs predetermined decode processing corresponding to the signal processing method by which band compression processing has been performed at recording time on the audio data supplied from the reproduction data separation processing system 53. The decoded result is subjected to D/A conversion processing by an audio D/A conversion processing system 57, and the obtained audio signal is output to the outside.

7.2.2 Digest Reproduction Mode and Chapter Mode

The signal processing method differs depending on whether the characteristic data, the playlist data, and the chapter data are recorded on the recording medium along with the video/audio data in the digest reproduction mode and the chapter mode. Whether the characteristic data and the playlist data is recorded on the recording medium is summarized as shown in FIG. 8.

7.2.2.1 When Playlist Data and/or Chapter Data is Recorded

This is a case corresponding to the cases of (a) and (b) in FIG. 8. The playlist data and the chapter data are recorded on the recording medium A and the recording medium B. With the use of the data, it is possible to perform the digest reproduction and the thumbnail display of the chapter images in the digest reproduction mode and the chapter display mode, respectively.

For example, when a command instructing the operation in the digest reproduction mode is supplied from the user input I/F system 61 to the system controller system 60, if the characteristic data, the playlist data, the chapter data, etc., are recorded on the recording medium A along with the video/audio data to be reproduced, such data is separated from the reproduction data separation processing system 53, and the separated characteristic data, playlist data, and chapter data are input into the system controller system 60.

The system controller system 60 performs control on the reproduction processing system 52, etc., and the skip reproduction based on the playlist data, thereby achieving the digest reproduction. Also, a display processing system 65 performs display processing of the images at the chapter points or in the vicinity thereof as thumbnail images, and thereby achieving the display of the thumbnail images.

In this regard, when it is not possible for the reproduction data separation processing system 53 to separate the characteristic data, the playlist data, and the chapter data, individual data is not input into the system controller system 60. Thus, the reproduction data separation processing system 53 and the system controller system 60 have a determination function of whether the characteristic data, the playlist data, and the chapter data are recorded on the recording medium A.

7.2.2.2 When Playlist Data and/or Chapter Data is not Recorded

This is a case corresponding to the cases of (c) and (d) in FIG. 8. The playlist data and the chapter data are pot recorded on the recording medium A and the recording medium B. In this state, it is not allowed to perform the digest reproduction processing of the video/audio data recorded on the recording media A and B in the digest reproduction mode. Also, a series of chapter-related processing, such as the display of the thumbnail images and chapter reproduction (reproduction for a predetermined time period on the basis of the position of the chapter image), etc., are not allowed.

This state is not the case where video/audio data obtained by receiving a broadcasting program is to be reproduced, but for example, is the case where the recording medium B is DVD software such as a movie sold in a package, and reproducing it. In addition, this is the case of reproducing the video/audio data whose characteristics are not extracted.

When the playlist data or the chapter data has not been generated, and reproduction is not allowed, the playlist data or the chapter data is generated. The above-described digest reproduction processing and the chapter-related processing are performed using the generated playlist data or chapter data. The generated playlist data or chapter data is appropriately recorded on the same recording medium as that of the video/audio data.

Also, when the reproduced playlist data or chapter data is re-generated, similarly, the playlist data for digest reproduction and the chapter data for chapter-related processing are generated from the reproduced characteristic data.

7.2.2.2.1 When Characteristic Data is Recorded

This is a case corresponding to the case of (c) in FIG. 8. When only the characteristic extraction processing is performed at recording time of the video/audio data (the generation processing of the playlist data or the chapter data is not performed) so that the characteristic data can be reproduced, the characteristic data is input from the reproduction processing system 52 or the reproduction data separation processing system 53 to the playlist data (chapter data) signal processing system 59. The playlist data (chapter data) signal processing system 59 generates the playlist data or the chapter data.

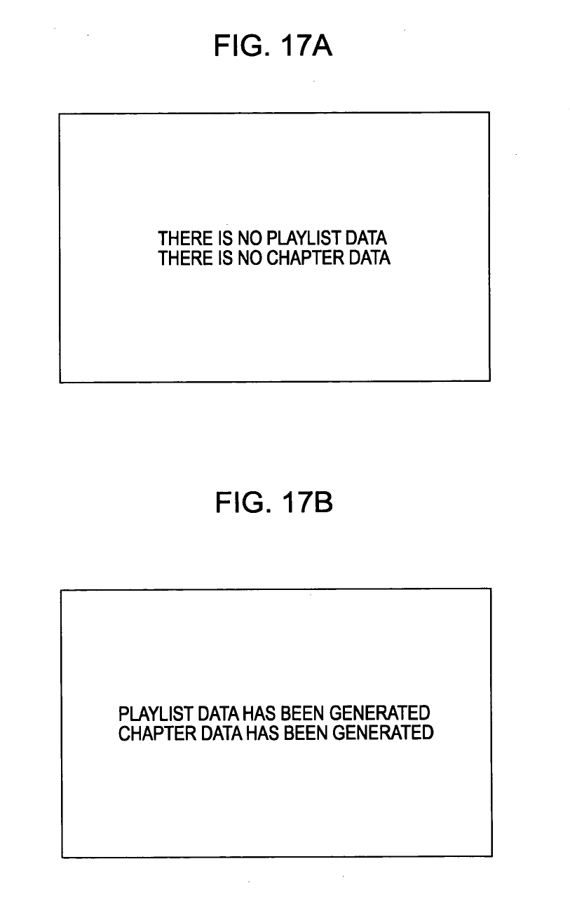

In this manner, if only the characteristic data can be reproduced, when the user instructs the digest reproduction mode, as shown in FIG. 17A, a message saying that there is no playlist data and no chapter data may be displayed by the display processing system 65. Also, when the playlist data or the chapter data is generated, a message as shown in FIG. 17B may be displayed by the display processing system 65.

The generated playlist data is input into the system controller system 60. The system controller system 60 performs control on the reproduction control system 58 so as to perform skip reproduction during a predetermined section on the basis of playlist data in accordance with the predetermined digest reproduction time by the user's operation. The reproduction control system 58 reproduces the data from the recording medium A.

Also, the generated chapter data is input into the system controller system 60. The system controller system 60 controls the reproduction control system 58 to perform predetermined chapter-related operations in accordance with the chapter-related operation mode due to the user operation, such as the thumbnail display of the images at which predetermined chapter points based on the chapter data are set, edit processing, for example cutting and connecting chapter points, skip reproduction of the chapter points selected by the user, and the like, and also controls on the display processing system 65.

For example, when the video/audio data recorded on the recording medium B is digest reproduced, the same processing as described above is performed, and the reproduction control system 58 controls the reproduction of the data from the recording medium B to achieve the digest reproduction processing. Also, when the chapter-related operations, such as edit processing (edit operation) using the chapter data, skip reproduction between the chapter points (or the vicinity thereof), thumbnail image display of the chapter points (or in the vicinity thereof), etc., are performed, the same processing as described above is performed, and the reproduction control system 58 controls the reproduction of the data from the recording medium B to achieve the chapter-related operations.

7.2.2.2.2 When Characteristic Data is not Recorded

This is a case corresponding to the case of (d) in FIG. 8. In the example described above, a description has been given of the case where the playlist data or the chapter data is generated from the characteristic data. However, for example when considering the case where the video/audio data recorded on the recording medium B by another user is copied to the recording medium A, the video/audio data is reproduced from the recording medium A, but the characteristic data is sometimes difficult to be reproduced.

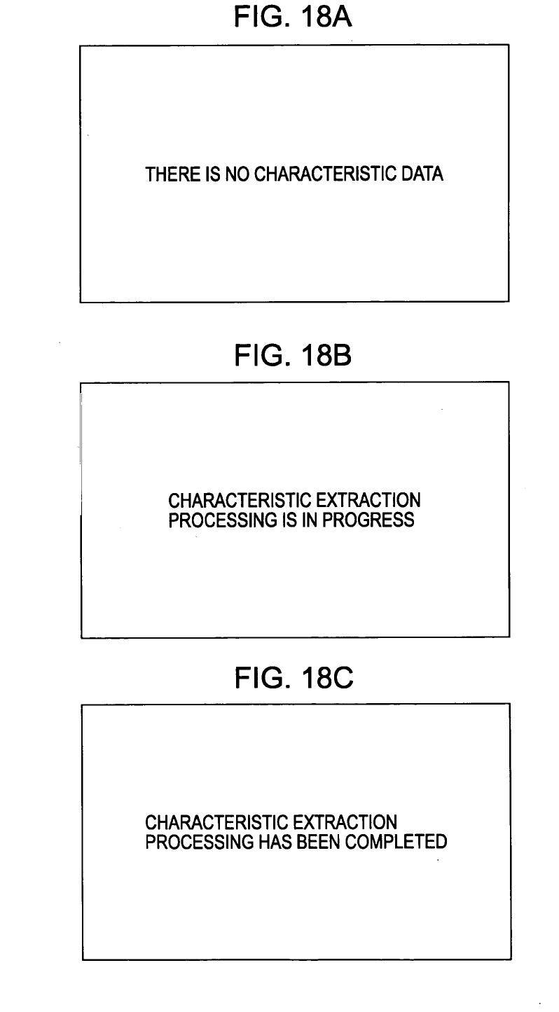

In this manner, when the video/audio data such as a broadcasting program is recorded on the recording medium A, but the characteristic data is not recorded and is difficult to be reproduced, if the user instructs the digest reproduction mode or the chapter-related operation mode, a message, as shown in FIG. 18A, indicating that there is no characteristic data may be displayed by the display processing system 65.

In this state, when the video/audio data recorded on the recording medium A is reproduced in the digest reproduction mode, the data reproduced by the reproduction processing system 52 is input into the reproduction data separation processing system 53, and the video data and the audio data separated by the reproduction data separation processing system 53 are input into the characteristic extraction processing system 50. The characteristic extraction processing system 50 performs the processing for detecting the DC coefficient, the AC coefficient, the motion vector, etc., of DCT, which are the characteristic data of the image, the processing for detecting the audio power, which is the audio characteristic data, and the like.

The characteristic extraction processing system 50 performs extraction processing of telop characteristic data (telop section determination data), person characteristic data, the other video characteristic data (video characteristic section determination data), and speaker audio characteristic data (speaker audio determination data), hand clapping and cheering characteristic data (hand clapping and cheering determination data), and the other audio characteristic data (audio characteristic section determination data) as necessary on the basis of various video/audio characteristic data as described above.

Various video characteristic data and audio characteristic data obtained by the characteristic extraction processing system 50 is sequentially input into the system controller system 60. When the characteristic extraction processing system 50 has performed the characteristic extraction processing on the predetermined program, or all of the predetermined video/audio section, it is determined that the characteristic extraction processing is completed.

Here, when the characteristic extraction processing is in progress, the signal indicating this state is input from the system controller system 60 to the display processing system 65. The display processing system 65 may, for example display a message as shown in FIG. 18B. Similarly, when the characteristic extraction processing has been completed, the display processing system 65 may, for example display a message as shown in FIG. 18C.

Next, a description will be given of the processing for generating the playlist data, or the chapter data from the characteristic data obtained as described above.

The characteristic data extracted by the characteristic extraction processing system 50 is, for example, temporarily stored into the memory system 51 for each data extracted from the predetermined target section. When the extraction of the characteristic data from all the sections has been completed, the characteristic data is input into the playlist data (chapter data) signal processing system 59, and the playlist data or the chapter data is generated on the basis of the characteristic data.

Here, the characteristic data extracted from a predetermined section may be sequentially input from the characteristic extraction processing system 50 directly to the playlist data (chapter data) signal processing system 59. As described above, by the signal output from the system controller system 60 when the extraction of the characteristic data from all the sections has been completed, the playlist data (chapter data) signal processing system 59 may start the generation of the playlist data or the chapter data. Also, the characteristic data extracted by the characteristic extraction processing system 50 may be input into the playlist data (chapter data) signal processing system 59 through the system controller system 60.

When the playlist data (chapter data) signal processing system 59 completes the generation of the playlist data or the chapter data, the signal indicating the completion is input from the playlist data (chapter data) signal processing system 59 to the system controller system 60. After that, the digest reproduction in accordance with the time requested by the user or the chapter-related operation requested by the user is performed.

When the generation of the playlist data or the chapter data is completed, the display as shown in FIG. 17B may be performed. Alternatively, when the processing is in progress on the basis of the generated playlist data or the chapter data, a message indicating that the current mode is the digest reproduction mode or the chapter-related operation mode may be displayed by the display processing system 65.

When the user performs digest reproduction, for example, assuming that the recorded broadcasting program takes one hour, the digest reproduction time requested by the user is not known. That is to say, whether the user wants to summarize the program in 30 minutes to reproduce it, or in 20 minutes is unknown. The playlist data corresponding to several kinds of summary time periods may be generated in advance in accordance with the total time length of all the sections from which the characteristic extraction of the video/audio data of the recorded broadcasting programs, etc., has been performed.

Specifically, assuming that the recording time of a broadcasting program is one hour, the playlist data is individually generated to be used for the digest reproduction for 40 minutes, 30 minutes, and 20 minutes. In this manner, by generating a plurality of kinds of playlist data, it becomes possible to immediately perform the digest reproduction operation corresponding to the selected time when the time selection has been done by the user's input into the remote controller 62, etc.

When the video/audio data recorded on the recording medium. B is reproduced, a recording medium processing system 64 detects the recording medium B, and a reproduction processing system 52 performs the reproduction of the video/audio data recorded on the detected recording medium B. The reproduction data separation processing system 53 performs the separation processing of the data reproduced by the reproduction processing system 52 into the video data and the audio data. The subsequent processing is the same as the case of reproducing the video/audio data recorded on the recording medium A as described above, and thus the detailed description thereof will be omitted.

8. Another Overall Configuration

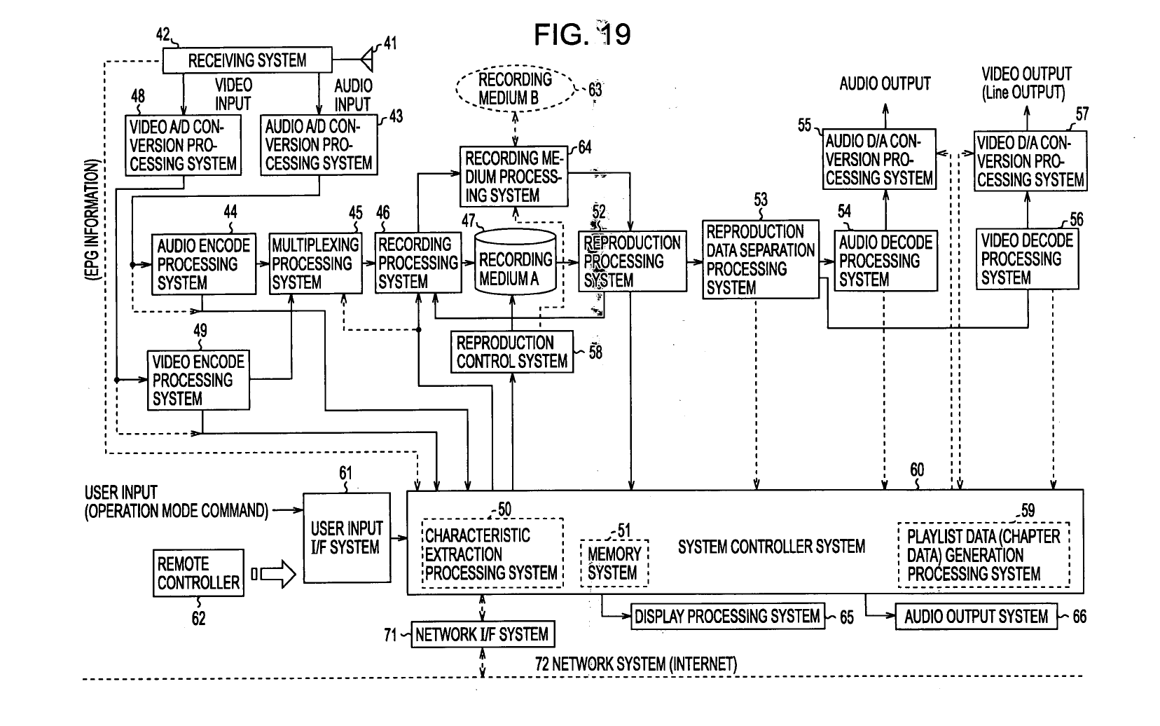

FIG. 19 is a block diagram illustrating another example of the configuration of the entire recording/reproducing apparatus. The same parts as those in FIG. 16 are marked with the same reference numerals. Duplicated description will be appropriately omitted.

8.1 Recording Configuration

The recording/reproducing apparatus in FIG. 19 is different from the recording/reproducing apparatus in FIG. 16 in that the extraction processing of the characteristic data at data recording time, and the generation processing of the playlist data or the chapter data are performed by software by the system controller system 60.

Also, in the recording/reproducing apparatus in FIG. 19, the software downloaded through a network system 72 including the Internet is executed by the system controller 60, and the characteristic extraction processing and the generation processing of the playlist data and the chapter data are appropriately performed.

By enabling the apparatus to download software, for example when there is an apparatus without the installation of a function of the characteristic extraction processing and the generation processing of the playlist data and the chapter data at first, it is advantageously possible to add such a function. Thus, when the design and production side find it difficult to provide a function of the characteristic extraction processing and the generation processing of the playlist data and the chapter data without delay because of the problems of time restriction for production and sales, or the like, it is possible to provide the system (recording/reproducing apparatus) having a simple configuration without such a function, and then later provide the user with such a function.

At the same time, the user can purchase a system having a simple configuration and without such a function, and then can add that function by software processing. Also, when each processing system is modified and improved, the user can handle it by downloading software (by upgrading).

When downloading such software, the user operates a remote controller 62, etc., to connect to a site on the Internet through the network system 72 in order to do so. The downloaded software is obtained by being uncompressed by the system controller 60, and the function is added by the installation thereof.

The above-described predetermined characteristic extraction processing, etc., can be performed simultaneously with the recording processing of the video/audio data with the use of a microprocessor (MPU of CPU) provided with a predetermined performance and having the constitution of the system controller system 60 in order to execute the software. Also, an internal data storage memory constituting the system controller system 60 as a memory system 51 may be used.

In this regard, when the band compression of a predetermined method is performed as the recording processing, the processing is considered to be performed by an MPU, a CPU, or a DSP (Digital Signal Processor) having a predetermined performance. The extraction processing of the characteristic data, and the generation processing of the playlist data or the chapter data may also be performed by the same MPU, CPU, or DSP which perform the band compression processing.

8.2 Reproduction Configuration

The reproduction configuration is the same as that of the case in FIG. 16, and thus the details of the processing performed by the reproduction configuration is omitted. The different point from the configuration in FIG. 16 is that the characteristic data is not allowed to be extracted in reproduction mode, and when it is necessary to perform the characteristic extraction processing, the system controller system 60 performs a series of the characteristic extraction processing by software.

For example, in the same manner as the printer at recording time, it is possible to perform the characteristic extraction processing at reproduction time and the generation processing of the playlist data or the chapter data simultaneously with the reproduction processing by causing the MPU, CPU, or the like constituting the system controller system 60 to perform the processing at reproduction time as well.

9. Characteristic Extraction Processing

Next, a detailed description will be given of the audio system characteristic extraction processing and video system characteristic extraction processing.

9.1 Audio System Characteristic Extraction Processing

9.1.1 Silent Characteristic Extraction Processing

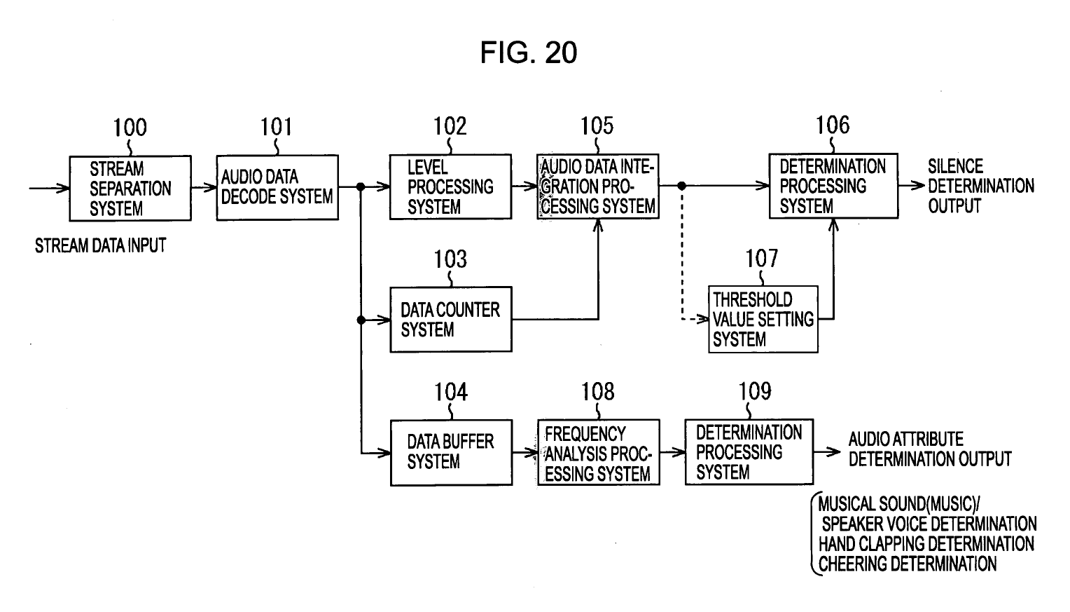

FIG. 20 is a block diagram illustrating an example of the configuration for extracting characteristics of an audio system.

In FIG. 20, video/audio data (stream data) compressed in the MPEG format is input into a stream separation system 100, and the audio data separated by the stream separation system 100 is input into an audio data decode system 101 to be subjected to predetermined decode processing.

The decoded audio data (audio signal) is individually input into a level processing system 102, a data counter system 103, and a data buffer system 104. The level processing system 102 performs the processing of obtaining the absolute value of the data in order to calculate an average power (or average level) Pₐᵥ of the audio data of a predetermined section. Until the data of a predetermined number of samples is measured by the data counter system 103, an audio data integration processing system 105 performs the integration processing.

Here, Pₐᵥ is obtained by the following expression (1) assuming that the value (level) of the audio data is Ad (n) (n indicates the position of the section where an average is calculated).
Expression 1

$${P}_{av} = {\sum }^{nd} \vert Ad ( n ) \vert / Sm \qquad ( 1 )$$

A predetermined section for calculating an average level is considered to be, for example, from about 0.01 second (10 ms) to 1 second. Assuming the sampling frequency Fs=48 kHz, the integration of samples 480 to 48000 is performed, and an average processing is performed by the number of samples Sm to obtain the average level (average power) Pₐᵥ.

The average level Pₐᵥ output from the audio data integration processing system 105 is input into a determination processing system 106, and is compared with a threshold value Ath set by a threshold value setting system 107 in order to perform determination processing on whether the section where the average level Pₐᵥ is calculated is a silent section.

Here, for the setting of the threshold value Ath by the threshold value setting system 107, Ath is considered to be set as a fixed value Ath0. However, a variable threshold value Athm in accordance with the average level of the audio section is considered to be set in addition to the fixed value Ath0.

For the variable threshold value Athm, for example assuming that a section to be processed is n, the average level Pₐᵥ (n-k) of the section (n-k) before the section is considered and the value expressed by the following expression (2) is considered to be used.
Expression 2

$${A}_{thm} = {\sum }_{k = 1}^{t} {P}_{av} ( n - k ) / m ( t \leq m ) \qquad ( 2 )$$

For example, assuming t=2, the variable threshold value Athm is expressed by the following expression (3).

Expression 3
Aₜₕₘ=(Pₐᵥ(n−1)+Pₐᵥ(n−2))/m (3)
where m is considered to be selected from the range of about 20 to 2.

9.1.2 Other Audio Characteristic Extraction Processing

The audio data stored in the data buffer system 104 is input into a frequency analysis processing system 108. The frequency analysis processing system 108 performs predetermined frequency analysis processing.

Here, FFT (Fast Fourier Transform), or the like is considered for frequency analysis processing. The number of analysis sample data of the data from the data buffer system 104 is set to be a predetermined number of samples of a power of two, for example, 512, 1024, 2048, and the others.

The data representing the analysis result by the frequency analysis processing system 108 is input into a determination processing system 109, and the determination processing system 109 performs predetermined determination processing.

Whether a section to be determined is a section of music (musical sound) can be determined, for example, on the basis of the continuity of the spectrum peaks of a predetermined frequency band. For example, Japanese Unexamined Patent Application Publication No. 2002-116784 has disclosed on this determination.

Whether a section to be processed is a section of a speaker's voice can be determined by the detection of a sharp rise section or fall section, because a sound waveform of a human conversation includes a sharp rise section or fall section due to breathing sections. In this case, in a musical signal waveform, there considered to be a low probability of appearance of rise sections or fall sections in general as compared with a signal waveform of a speaker's voice. Thus, a determination of the attribute of a musical signal may be made comprehensively in consideration of the characteristic of the musical waveforms.

Also, when the determination of the audio signal attribute is made from the difference between the waveform characteristic of a speaker's audio signal and the waveform characteristic of a music signal, the physical characteristic of the waveform in time is detected. Thus, a method of performing the determination processing in the baseband domain (signal analysis, determination processing in time domain) is considered in addition to the method in which frequency analysis described above is performed and then the determination processing is performed (signal analysis and the determination processing in the frequency domain).

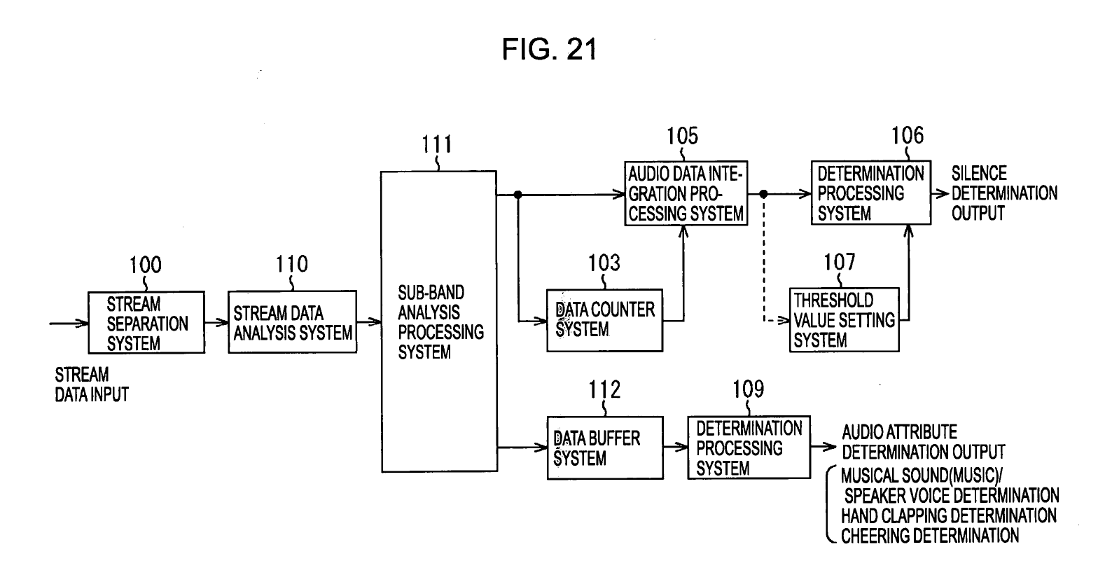

FIG. 21 is a diagram illustrating an example of the configuration of the case in which an analysis is made on the attribute of the signal as compressed without the audio signal (audio data) being subjected to decode processing. The same parts as those in FIG. 20 are marked with the same reference numerals.

The video/audio data compressed by the MPEG format is input into a stream separation system 100, and the stream separation system 100 separates the video/audio data into video data and audio data. The separated audio data is input into a stream data analysis system 110 to be subjected to signal analysis processing with a predetermined sampling frequency and a predetermined number of quantifying bits. The obtained audio data is input into a sub-band analysis processing system 111.

The sub-band analysis processing system 111 performs sub-band analysis processing, and predetermined sub-band band data is subjected to the same predetermined signal processing as those expressed by the above expressions (1) to (3).

That is to say, the result of the sub-band analysis processing by the sub-band analysis processing system 111 is input into an audio data integration processing system 105. Until the data of a predetermined number of samples is detected by the data counter system 103, an audio data integration processing system 105 performs the integration processing. Also, after that, a determination processing system 106 performs determination processing on whether the section to be currently processed is a silent section on the basis of a threshold value set by a threshold value setting system 107.

The silent section determination processing here is considered to use sub-band band data of about 3 kHz or less, which is an energy-concentrating band in consideration of the audio data spectrum.

Also, a description has been given of the determination processing of musical sound and a speaker's voice by the frequency analysis. According to the configuration in FIG. 21, the sub-band analysis processing system 111 is considered to have performed the frequency analysis, and thus the attribute determination may be performed by the continuation processing of predetermined peak spectrums described above. In this case, the peak spectrums can be considered to be a maximum data band among each sub-band, and can be subject to the same signal processing as the case of the FFT analysis processing.

9.2 Video System Characteristic Extraction Processing

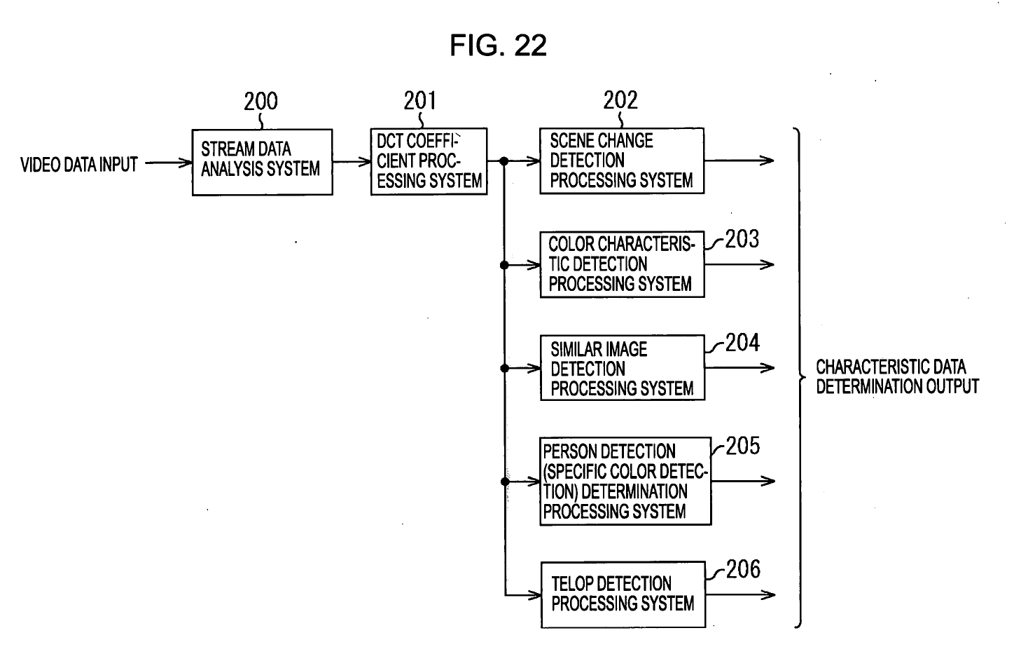

Next, a description will be given of video system characteristic extraction processing. FIG. 22 is a block diagram illustrating an example of the configuration for extracting characteristics of a video system.

In FIG. 22, for example the video data obtained by a stream separation system (not shown) performing predetermined separation processing is input into a stream data analysis system 200. The stream data analysis system 200 performs predetermined data analysis, such as rate detection, number of pixels detection, etc., and outputs the analysis result to a DCT coefficient processing system 201.

The DCT coefficient processing system 201 performs predetermined DCT calculation processing (inverted DCT calculation processing) such as the DCT coefficient detection, the AC coefficient detection of DCT, etc. Each subsequent-stage processing system performs video characteristic extraction processing on the basis of the processing result.

9.2.1 Scene Change Characteristic

A scene change detection processing system 202, for example, divides one frame image into a predetermined number of areas, and calculates average values of Y (luminance data), Cb and Cr (color difference data) of the DCT coefficient data of DCT for each area. Also, scene change detection processing system 202 calculates a difference between frames or a difference between fields on the basis of the calculated average value, and detects scene changes by the comparison with a predetermined threshold value.

When there is no scene change, difference data between frames (or fields) of each area is smaller than a predetermined threshold value. When there is a scene change, the difference data is larger than the predetermined threshold value. Thus, scene changes can be detected on the basis of the comparison.

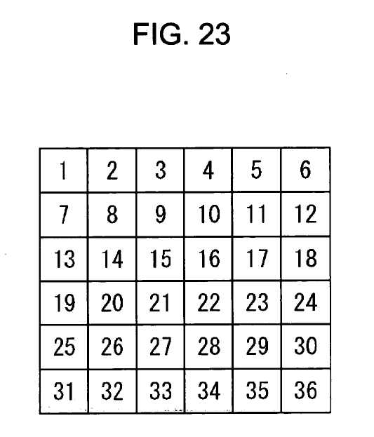

Here, the number of divisions of one frame may be 36 as shown in FIG. 23 for example. The division of the frame are is not limited to that shown in FIG. 23, and the number of divisions may be increased or decreased. However, if the number is too small, the detection precision of scene changes become dull, and if the number is too large, the precision becomes too sharp. Thus, an appropriate number of divisions is considered to be set in the range of about 4 to 400.

9.2.2 Color Characteristic

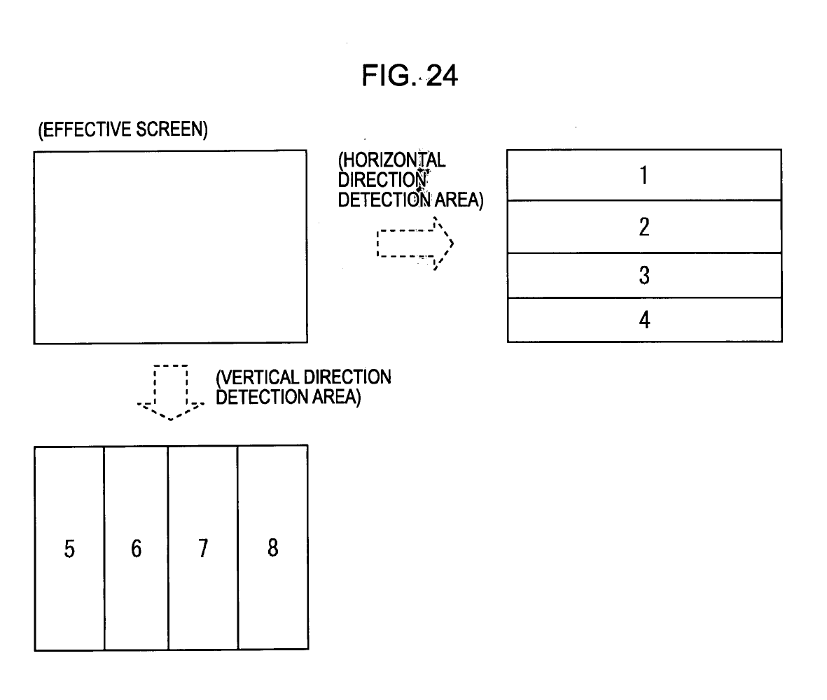

From the average values of Y, Cb, and Cr of the DCT coefficient data of DCT for predetermined areas, a color characteristic detection processing system 203 can detect color characteristics. For a predetermined areas, for example the areas shown in FIG. 24 can be considered.

For example, when the category of the broadcasting program is “sumo” (Japanese-style wrestling), if an area including brown color is detected from the areas in FIG. 24, the scene is assumed to be “a scene of a sumo ring” with high probability.

By the combination of such a color characteristic and a voice cheering characteristic, it can be assumed that a currently noticed scene is “a scene of starting a match” with high probability from the “a scene of a sumo ring” plus “a cheering scene”. Such a scene section is set to be a key frame section.

9.2.3 Similar Scene Characteristic

This is processing by a similar image detection processing system 204 for detecting similar images (scenes) and for assigning (giving or adding) the same ID to similar scenes. The details thereof have been disclosed, for example in Japanese Unexamined Patent Application Publication No. 2002-344872.

In this processing, for example one frame is divided into a plurality of areas (for example, 25 areas), and the average DC coefficient of DCT of each divided area is obtained. Also, when a vector distance among each scene using the obtained average DC coefficients as vector components is smaller than a predetermined threshold value, those scenes are determined to be similar scenes. The same ID is assigned to the scenes that are determined as similar scenes.

The initial value of the ID to be assigned is set to be 1, for example. When a scene having a vector distance smaller than the above-described predetermined threshold value is not detected, 1 added to the maximum value of the ID is used as a new ID, and is assigned to the scene.

9.2.4 Telop Characteristic

In a telop detection determination processing system 206, for example the average value of the AC coefficient of DCT in each area as shown in FIG. 24 is obtained. A telop including character information of a predetermined size or more has a relatively clear outline. Thus, when a telop appears in any one of the areas shown in FIG. 24, it is possible to detect an AC coefficient of a predetermined threshold value or more, and thereby the telop is detected.

In this manner, in addition to a method of detecting an AC coefficient of DCT, a method of detecting an edge in the baseband domain (signal in time domain) is considered. For example, edge detection by a difference among frames of image luminance data can be considered. Also, multiple resolution analysis may be performed by the wavelet transformation. Thus, the average value of areas may be calculated using data in a predetermined multiple resolution analysis area including predetermined high-frequency components, and thereby the same processing may be performed as the case of using the above-described AC coefficients.

In addition, in FIG. 22, a specific color determination processing system 205 detects a specific color (for example, a flesh color), and thus detects a face. Thereby, a person is considered to be detected.

The characteristic data obtained by each system in FIGS. 20 to 22 as described above is supplied to the outside (for example, a playlist data (chapter data) signal processing system 59 in FIG. 16), and is used for generating the playlist data and the chapter data.

10. Embodiment of when Large-Capacity Recording Medium and Another Recording Medium are Used Together

This embodiment corresponds to operation modes, such as data copying/recording processing and edit/recording processing from the recording medium A corresponding to “a large-capacity recording medium” to the recording medium B corresponding to “another recording medium” in a recording/reproducing apparatus shown in FIG. 16 or FIG. 19.

Here, the recording medium B, for example corresponds to a plurality of recording formats as described above, is provided with a plurality of recording layers to be the data recording destinations of individual recording formats, and is an optical disc removable from a recording/reproducing apparatus. In this manner, the user may use recording media by directly copying (copying/recording processing) or by editing and then copying (edit/recording processing) the video/audio data recorded on a large-capacity recording medium, such as an HDD (recording medium A), etc., to a predetermined recording layer corresponding to a recording format or a recording rate of an optical disc (recording medium B) which is removable from a recording/reproducing apparatus and has a smaller recording capacity than the HDD.

Such copying/recording processing, edit/recording processing, etc., is performed, for example automatically on the basis of the operation mode of the recording/reproducing apparatus, or manually by the user's operation.

Here, suppose that video/audio data of the two formats, the recording format 1 (the normal DVD format) and the recording format 2 (the BD format or the HD-DVD format), and the characteristic data and special reproduction data (playlist data and chapter data) are recorded on the recording medium A in FIG. 16 or FIG. 19.

In the following, a description will be given of the copying/recording processing (copy operation mode). For example, when a recording/reproducing apparatus enters the copy operation mode in accordance with the user's operation, in the first place, a determination is made on recording formats that can be used for the recording medium B, which is mounted on the recording/reproducing apparatus and becomes the data copy destination.

10.1 How to Determine Available Recording Formats

In the recording/reproducing apparatus, a signal processing system as shown in FIG. 3 performs data recording on the recording medium B in the recording format 1 and the recording format 2. Also, a signal processing system as shown in FIG. 5 performs data reproduction on the recording medium B recorded in the recording format 1 and the recording format 2. That is to say, the signal processing system in FIG. 3 corresponds to a recording side of the sign processing system in the recording/reproducing apparatus in FIG. 16 or FIG. 19, and the signal processing system in FIG. 5 corresponds to a reproducing side of the sign processing system in the recording/reproducing apparatus in FIG. 16 or FIG. 19.

The confirmation on which recording format the recording medium B is corresponding to is carried out by, for example, recording test data of the recording format 1 and the recording format 2 on the corresponding layers of the recording medium B individually and then determining on whether the test data recorded just before can be normally reproduced in the reproduction mode.

Also, a determination at this time on whether the test data can be reproduced normally is automatically made by the detection of the error rate or the detection of the ECC flag ((Error-Correcting Code) flag) by the error-correction signal processing system not shown and disposed in a reproduction signal processing system, etc. Specifically, the ECC flag signal is input from the reproduction processing system 52 in FIG. 16 or FIG. 19 into the system controller system 60, and the determination is automatically made by the comparison of the number of flags measured in a predetermined time period in the system controller system 60 with a predetermined threshold value.

When a physical identification (ID) is set in the recording medium B, the identification (ID) may be detected and it may be confirmed which recording format the recording medium B corresponds to on the basis of the identification (ID). In this case, the recording/reproducing apparatus is provided with, for example a corresponding table of the identification (ID) and the recording format.

10.2 Recording Methods

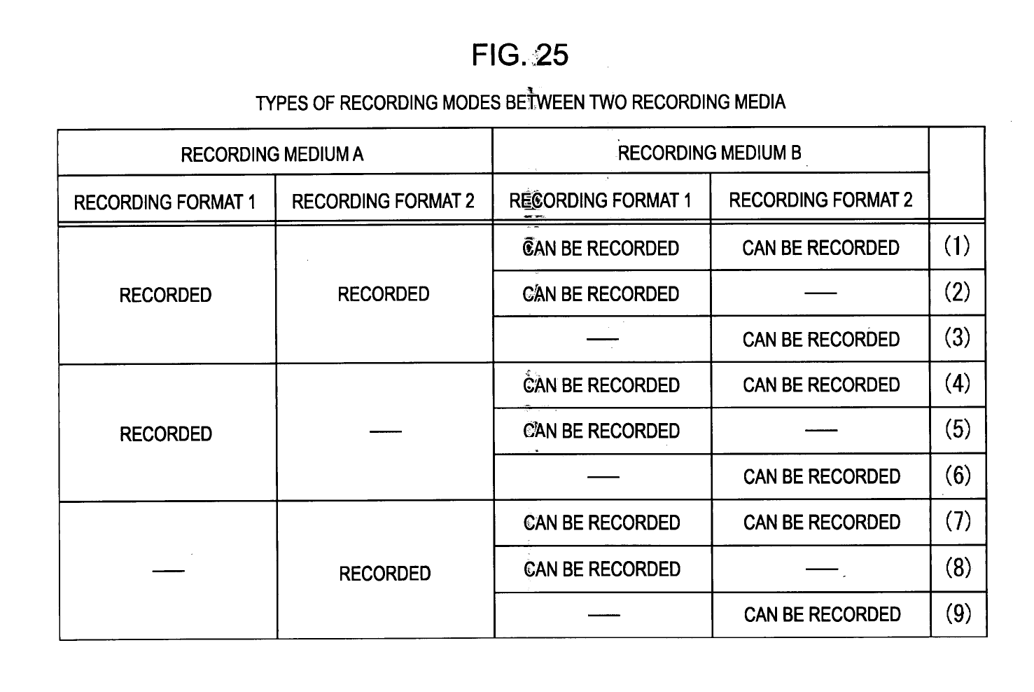

FIG. 25 is a diagram illustrating an example of combinations of data recording states of a recording medium A and recording formats allowed for recording on a recording medium B. The recording operations, such as data copying/recording processing, edit recording processing, etc., are performed in accordance with the combinations in this diagram.

FIG. 25, (1) shows the combination of the case where data in recording format 1 and recording format 2 are recorded on the recording medium A and the recording format B is corresponding to both the recording format 1 and the recording format 2. Also, FIG. 25, (2) shows the combination of the case where data in recording format 1 and recording format 2 are recorded on the recording medium A and the recording format B is corresponding to only the recording format 1. Furthermore, FIG. 25, (3) shows the combination of the case where data in recording format 1 and recording format 2 are recorded on the recording medium A and the recording format B is corresponding to only the recording format 2.

Similarly, FIG. 25, (4) shows the combination of the case where only data in recording format 1 is recorded on the recording medium A and the recording format B is corresponding to both the recording format 1 and the recording format 2. Also, FIG. 25, (5) shows the combination of the case where only data in recording format 1 is recorded on the recording medium A and the recording format B is corresponding to only the recording format 1. Furthermore, FIG. 25, (6) shows the combination of the case where only data in recording format 1 is recorded on the recording medium A and the recording format B is corresponding to only the recording format 2.

FIG. 25, (7) shows the combination of the case where only data in recording format 2 is recorded on the recording medium A and the recording format B is corresponding to both the recording format 1 and the recording format 2. Also, FIG. 25, (8) shows the combination of the case where only data in recording format 2 is recorded on the recording medium A and the recording format B is corresponding to only the recording format 1. Furthermore, FIG. 25, (9) shows the combination of the case where only data in recording format 2 is recorded on the recording medium A and the recording format B is corresponding to only the recording format 2.

In this regard, in the above, a description has been given of the processing of copying data from the recording medium A to the recording medium B. However, the opposite processing, that is to say, the processing of copying data from the recording medium B to the recording medium A is performed in the same manner. Also, a description has been given assuming that the recording medium B is a disc-shaped recording medium removable from a tray disposed on the recording/reproducing apparatus. However, the recording medium B is not limited to this. The same thing can be performed when the data recorded on the recording format A is recorded on an external recording medium, such as an USB (Universal Serial Bus) connected recording medium which is connected to a recording/reproducing apparatus through a predetermined cable, an IEEE (Institute of Electrical and Electronics Engineers) 1394-connected recording medium, or on the contrary, when data is recorded from the external recording medium to the recording medium A.

Next, a detailed description will be given of the operation in each combination state shown in FIG. 25.

10.2.1 When Data of Both Recording Format 1 and Recording Format 2 is Recorded on Recording Medium A

In the case of FIG. 25, (1):

This is the case where the recording medium B is determined to be corresponding to both the recording format 1 and the recording format 2 by the system controller system 60, and the video/audio data recorded on the recording medium A is recorded on the recording medium B in both the recording format 1 and the recording format 2.

For example, as described above, after the available recording format on the recording medium B is automatically determined, the video/audio data of the recording format 2 having a higher transfer rate than the data in the recording format 1 is reproduced by the reproduction processing system 52 from the recording medium A, is subjected to predetermined recording processing by the recording processing system 46, and then is recorded on the recording format dual-layer of the recording medium B through the recording medium processing system 64.

Similarly, the video/audio data of the recording format 1 is reproduced by the reproduction processing system 52, is subjected to predetermined recording processing by the recording processing system 46, and then is recorded on the recording format single-layer of the recording medium B through the recording medium processing system 64.

In this regard, at the time of such recording, the characteristic data, special reproduction data, etc., are also read from the recording medium A, and are recorded on the predetermined recording layer and recording area as described with reference to FIGS. 7 and 10.

In the case of FIG. 25, (2):

This is the case where the recording medium B is determined to be corresponding only to the recording format 1 (normal DVD format) by the system controller system 60, and the video/audio data recorded on the recording medium A is recorded on the recording medium B in the recording format 1.

The video/audio data of the recording format 1 is reproduced by the reproduction processing system 52, is subjected to predetermined recording processing by the recording processing system 46, and then is recorded on the recording format single-layer of the recording medium B through the recording medium processing system 64.

In this regard, in this recording mode, the characteristic data, special reproduction data, etc., are also read from the recording medium A, and are recorded on the predetermined recording layer and recording area as described with reference to FIGS. 7 and 10. However, in the case of FIG. 25, (2), this data is recorded only on the recording format single-layer, or another predetermined recording area.

In the case of FIG. 25, (3):

This is the case where the recording medium B is determined to be corresponding only to the recording format 2 (BD format or HD-DVD format) by the system controller system 60, and the video/audio data recorded on the recording medium A is recorded on the recording medium B in the recording format 2.

The video/audio data of the recording format 2 having a higher transfer rate than the data in the recording format 1 is reproduced by the reproduction processing system 52 from the recording medium A, is subjected to predetermined recording processing by the recording processing system 46, and then is recorded on the recording format dual-layer of the recording medium B through the recording medium processing system 64.

In this regard, at the time of such recording, the characteristic data, special reproduction data, etc., are also read from the recording medium A, and are recorded on the predetermined recording layer and recording area as described with reference to FIGS. 7 and 10. However, in the case of FIG. 25, (3), this data is recorded only on the recording format dual-layer, or another predetermined recording area.

10.2.2 When Only Data of Recording Format 1 is Recorded on Recording Medium A

In the case of FIG. 25, (4):

This is the case where the recording medium B is determined to be corresponding to both the recording format 1 and the recording format 2 by the system controller system 60, and the video/audio data recorded on the recording medium A is recorded on the recording medium B in both the recording format 1 and the recording format 2.

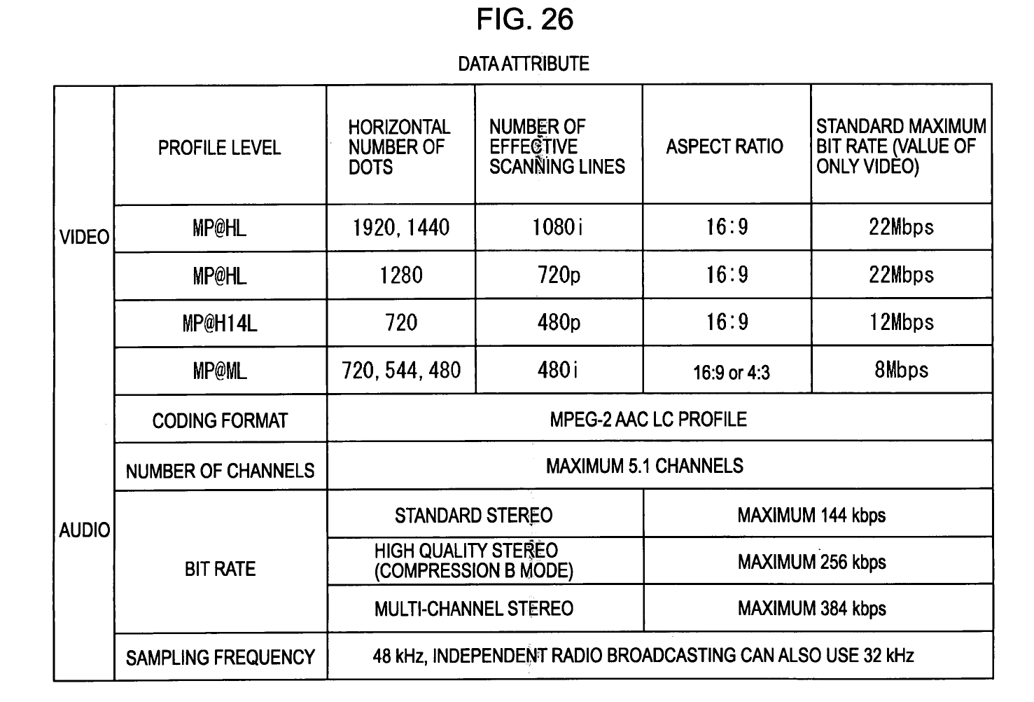

In this case, only the video/audio data of the recording format 1 (normal DVD format) is recorded on the recording medium A, and there is no video/audio data of the recording format 2 having a high transfer rate. Thus, the video/audio data of the recording format 1 is subjected to up-convert processing to generate the video/audio data of the recording format 2. This is considered to be conversion processing from MP@ML to MP@HL in the MPEG format as shown in FIG. 26.

The MPEG attributes, such as a profile, a level, a screen-size ratio (aspect ratio), etc., shown in FIG. 26 can be confirmed by detecting a predetermined bit data disposed in the video/audio data. In the recording/reproducing apparatus shown in FIG. 16 or FIG. 19, the system controller system 60 performs the confirmation by a signal from the reproduction processing system 52, the audio decode processing system 54, or the video decode processing system 56.

The video/audio data of the recording format 1 is reproduced by the reproduction processing system 52, and the reproduced video/audio data is input into the recording processing system 46. The recording processing system 46 performs up-convert processing, and the video/audio data of the recording format 2 obtained by the up-convert processing is recorded onto the recording format dual-layer of the recording medium B through the recording medium processing system 64.

For up-convert processing, a method in which the video/audio data of the recording format 1, which is a reproduction signal, is decoded and then is encoded again in the recording format 2 is considered. However, a method of performing a predetermined transfer-rate conversion, screen-size conversion (conversion from 4 to 3 into 16 to 9), the other conversion processing, etc., without decoding the band-compressed video/audio data in the recording format 1 into the base band is also considered.

In this regard, when the video/audio data of the recording format 1 is considered as simple data, and the data is recorded onto the recording format dual-layer of the recording medium B, for example as MP@ML without change, the read data may be directly recorded without performing the up-convert processing, the screen-size conversion processing, etc., as described above.

On the other hand, the video/audio data of the recording format 1 is reproduced by the reproduction processing system 52, is subjected to predetermined recording processing by the recording processing system 46, and then is recorded on the recording format single-layer of the recording medium B through the recording medium processing system 64.

In this recording mode, the characteristic data, special reproduction data, etc., are also read from the recording medium A, and are recorded on the predetermined recording layer and recording area as described with reference to FIGS. 7 and 10.

In the case of FIG. 25, (5):

This is the case where the recording medium B is determined to be corresponding only to the recording format 1 (normal DVD format) by the system controller system 60, and the video/audio data recorded on the recording medium A is recorded on the recording medium B in the recording format 1.

The video/audio data of the recording format 1 is reproduced by the reproduction processing system 52, is subjected to predetermined recording processing by the recording processing system 46, and then is recorded on the recording format single-layer of the recording medium B through the recording medium processing system 64.

In this regard, at the time of such recording, the characteristic data, special reproduction data, etc., are also read from the recording medium A, and are recorded on the predetermined recording layer and recording area as described with reference to FIGS. 7 and 10. However, in the case of FIG. 25, (5), this data is recorded only on the recording format single-layer, or another predetermined recording area.

In the case of FIG. 25, (6):

This is the case where the recording medium B is determined to be corresponding only to the recording format 2 (BD format or HD-DVD format) by the system controller system 60, and the video/audio data recorded on the recording medium A is recorded on the recording medium B in the recording format 2.

In this case, only the video/audio data of the recording format 1 (normal DVD format) is recorded on the recording medium A, and there is no video/audio data of the recording format 2 having a high transfer rate. Thus, the video/audio data of the recording format 1 is subjected to up-convert processing to generate the video/audio data of the recording format 2. That is to say, the same processing as “in the case of FIG. 25, (4)” described above is performed.

In this regard, in this recording mode, the characteristic data, special reproduction data, etc., are also read from the recording medium A, and are recorded on the predetermined recording layer and recording area as described with reference to FIGS. 7 and 10. However, in the case of FIG. 25, (6), this data is recorded only on the recording format dual-layer, or another predetermined recording area.

10.2.3 When Only Data of Recording Format 2 is Recorded on Recording Medium A

In the case of FIG. 25, (7):

This is the case where the recording medium B is determined to be corresponding to both the recording format 1 and the recording format 2 by the system controller system 60, and the video/audio data recorded on the recording medium A is recorded on the recording medium B in both the recording format 1 and the recording format 2.

In this case, only the video/audio data of the recording format 2 (BD format or HD-DVD format) is recorded on the recording medium A, and there is no video/audio data of the recording format 1 having a low transfer rate. Thus, the video/audio data of the recording format 2 is subjected to down-convert processing to generate the video/audio data of the recording format 1.

The video/audio data of the recording format 2 is reproduced by the reproduction processing system 52, and the reproduced video/audio data is input into the recording processing system 46. The recording processing system 46 performs down-convert processing, and the video/audio data of the recording format 1 obtained by the down-convert processing is recorded on the recording format single-layer of the recording medium B through the recording medium processing system 64.

For down-convert processing, a method in which the video/audio data of the recording format 2, which is a reproduction signal, is decoded and then is encoded again in the recording format 1 is considered. However, a method of performing a predetermined transfer-rate conversion, screen-size conversion (conversion from 16 to 9 into 4 to 3), the other conversion processing, etc., without decoding the band-compressed video/audio data in the recording format 2 into the baseband is also considered.

In this regard, when the video/audio data of the recording format 2 recorded on the recording medium A is the MP@ML data of MPEG shown in FIG. 26, the read data may be directly recorded without performing the down-convert processing, the screen-size conversion processing, etc., as described above.

On the other hand, the video/audio data of the recording format 2 is reproduced by the reproduction processing system 52, is subjected to predetermined recording processing by the recording processing system 46, and then is recorded on the recording format dual-layer of the recording medium B through the recording medium processing system 64.

At the time of this recording, the characteristic data, special reproduction data, etc., are also read from the recording medium A, and are recorded, on the predetermined recording layer and recording area as described with reference to FIGS. 7 and 10.

In the case of FIG. 25, (8):

This is the case where the recording medium B is determined to be corresponding only to the recording format 1 (normal DVD format) by the system controller system 60, and the video/audio data recorded on the recording medium A is recorded on the recording medium B in the recording format 1.

In this case, only the video/audio data of the recording format 2 (BD format or HD-DVD format) is recorded on the recording medium A, and there is no video/audio data of the recording format 1 having a low transfer rate. Thus, the video/audio data of the recording format 2 is subjected to down-convert processing to generate the video/audio data of the recording format 1. That is to say, the same processing as “in the case of FIG. 25, (7)” described above is performed.

In this regard, in this recording mode, the characteristic data, special reproduction data, etc., are also read from the recording medium A, and are recorded on the predetermined recording layer and recording area as described with reference to FIGS. 7 and 10. However, in the case of FIG. 25, (8), this data is recorded only on the recording format single-layer, or another predetermined recording area.

In the case of FIG. 25, (9):

This is the case where the recording medium B is determined to be corresponding only to the recording format 2 (BD format or HD-DVD format) by the system controller system 60, and the video/audio data recorded on the recording medium A is recorded on the recording medium B in the recording format 2.

The video/audio data of the recording format 2 having a higher transfer rate than the data in the recording format 1 is reproduced by the reproduction processing system 52 from the recording medium A, is subjected to predetermined recording processing by the recording processing system 46, and then is recorded on the recording format dual-layer of the recording medium B through the recording medium processing system 64.

In this regard, at the time of such recording, the characteristic data, special reproduction data, etc., are also read from the recording medium A, and are recorded on the predetermined recording layer and recording area as described with reference to FIGS. 7 and 10. However, in the case of FIG. 25, (9), this data is recorded only on the recording format dual-layer, or another predetermined recording area.

11. Embodiment of when a Plurality of Pieces of Video/Audio Data in Recording Format 1 are Recorded in Recording Format 2

A plurality of pieces of video/audio data in a recording format having a low recording rate (transfer rate) are sometimes recorded again as video/audio data in a recording format having a higher recording rate.

The recording capacity of the recording format dual-layer corresponding to the BD format or the HD-DVD format among the recording layers of the recording medium B is larger than the recording capacity of the recording format single-layer corresponding to the normal DVD format. Thus, for example the recording of a plurality of pieces of the video/audio data in recording format 1 in the recording format 2 is carried out when a plurality of pieces of the recorded video/audio data in the normal DVD format are recorded on the recording format dual-layer of one piece of the recording medium B as the video/audio data in the BD format or the HD-DVD format.

Here, the recording capacity of a recording medium in the BD format and the recording capacity of a recording medium in the normal DVD format are considered.

The BD format disc can hold up to 27 GB on a single-layer disc, and the normal DVD format disc can hold up to 4.7 GB.

Thus, 27/4.7=5.7

Accordingly, the data recorded on at least five pieces of normal DVD format discs can be recorded on one piece of the BD format disc.

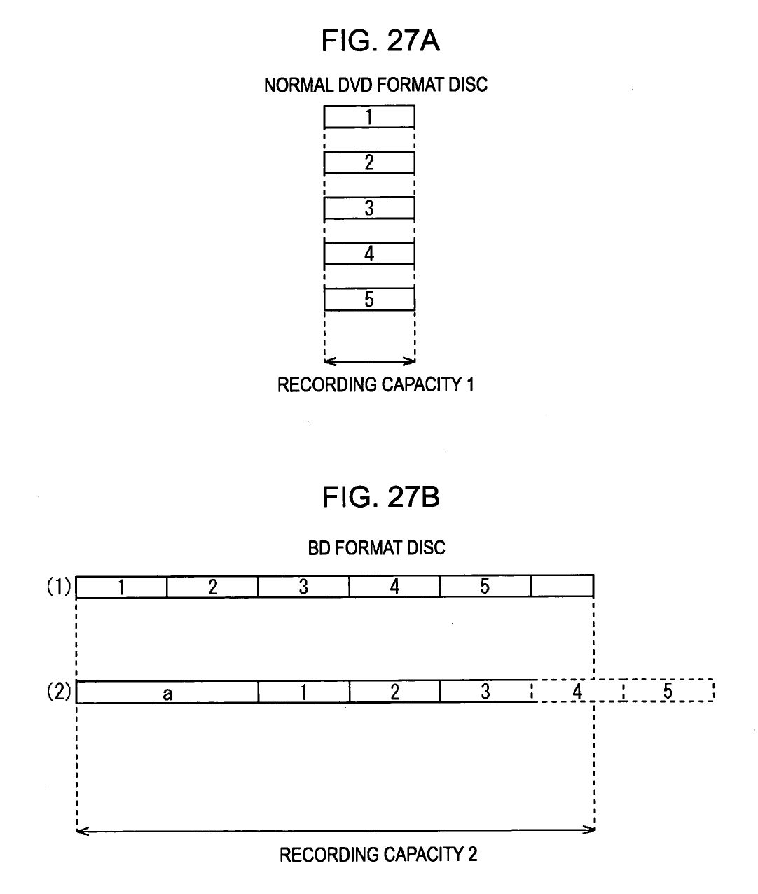

FIGS. 27A and 27B are diagrams illustrating the recording capacities of the normal DVD format recording media and the BD format recording medium, respectively. In the example in FIG. 27A, the recording capacity of the normal DVD format disc is represented by a recording capacity 1.

As shown in FIG. 27B, (1), the amount of the total recording capacity of the normal DVD format discs 1 to 5 is smaller than the amount of recording capacity 2 of one BD format disc.

Such an operation of copying/recording a plurality of pieces of video/audio data recorded on a plurality of recording media on one recording medium is performed by the recording/reproducing apparatus in accordance with a user's predetermined operation.

11.1 Setting Sequence of Operation Mode and Operation Sequence

For performing such an operation, first, the user operates the remote controller 62 in order to select and set an operation mode.

Next, the selection of how many normal DVD format discs are copied to one BD format disc is input from the remote controller 62, etc. The input information is entered into the system controller system 60 through the user input I/F system 61.

When such an operation is performed by the user, if the data recorded on a predetermined number of normal DVD format discs, which has been specified by the user, is not accommodated in one BD format disc, for example a display processing system 65 may perform a predetermined warning display, or an audio output system 66 may output a predetermined warning sound under the control of the system controller system 60. For a warning sound, for example a beep sound, or a synthetic voice, such as “unable to record on one disc” based on the voice data stored in a ROM, etc., in the system controller system 60.

FIG. 27B, (2) is a schematic diagram illustrating the case where the data of the user-specified number of normal DVD format discs is difficult to be recorded on one BD format disc.

In the example in FIG. 27B, (2), the data of the amount a has already been recorded on the recording destination BD format disc, and thus only the normal DVD format discs 1 to 3 are allowed to be recorded on the BD format disc additionally.

When all the data to be recorded is not allowed to be recorded on one BD format disc, for example if two BD format discs can accommodate all the data, the voice data may be read from the memory in the system controller system 60 in order to output voice information, such as “can be recorded on 2 discs” by the audio output system 66. Alternatively, a predetermined message may be displayed by the display processing system 65.

In the process of recording the data recorded on the normal DVD format disc on the BD format disc, as described above, for example when predetermined signal processing, such as screen-size conversion from 4 to 3 into 16 to 9, re-encode processing, etc., it is possible to apply signal processing as in the case of the combinations of FIG. 25, (4) and (6) to that processing. Also, in order to record the characteristic data and the special reproduction data recorded on the normal DVD format disc, it is possible to apply the processing described with reference to FIGS. 7 and 10.

12. Embodiment of when Recording Capacity is Insufficient

12.1 When Disc Supporting Two-Recording Format is Used

For example, while data having a relatively high transfer rate such as MP@HL, etc., is being recorded on the recording medium B in the recording format 2, the recording capacity of the recording format dual-layer corresponding to the recording format 2 of the recording medium B sometimes becomes insufficient. Thus, it becomes difficult to record all the video/audio data to be recorded. This situation may occur when, for example timer recording is set using an EPG (Electronic Program Guide), etc., the broadcasting of a program (for example, a sport program) in accordance with the timer does not end at a scheduled time, and the recording is extended with the extension of the broadcasting time.

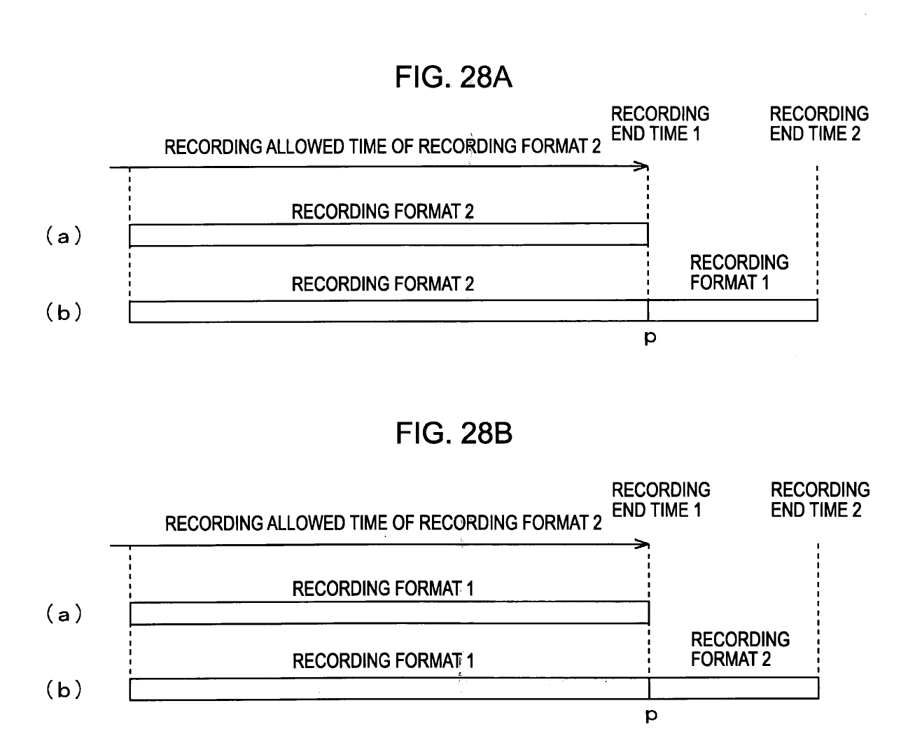

As described above, assuming that the recording medium B in FIG. 16 or FIG. 19 is corresponding to the recording format 1 (normal DVD format) and the recording format 2 (BD format or HD-DVD format), when insufficient recording capacity of the recording format dual-layer is detected during the recording of data in the recording format 2 having a high transfer rate, the recording format is changed from the recording format 2 to the recording format 1 at p point (the time 1) in the middle of the recording in FIG. 28A, and then data is recorded in the recording format 1 until the time 2, at which the recording of the program being processed is terminated.

In this regard, FIG. 28B shows the example of the case where the recording format is changed from the recording format 1 to recording format 2. The recording format is changed from the recording format 1 to the recording format 2 at p point (the time 1) in the middle of the recording, and then data is recorded in the recording format 2 until the time 2, at which the recording of the program being processed is terminated.

When the recording format is changed in this manner, as described with reference to FIG. 3, the data recording destination is the recording layer corresponding to the changed recording format. Also, the recording destination of the characteristic data and the special reproduction data is changed along with the recording format change as necessary.

Also, for example when the characteristic-data extraction processing to be the basis of generating the special reproduction data is performed using the video/audio data of the recording format 2, that characteristic extraction processing is also changed to the processing using the video/audio data in the recording format 1.

Furthermore, when the characteristic extraction processing is performed in the baseband area of the video/audio data before performing predetermined band compression processing, even if the recording format is changed, the output of the characteristic processing is used directly, and the recording destination of the characteristic data is changed to the area (position) as described with reference to FIG. 7 or FIG. 10. When the area other than the recording format single-layer corresponding to the recording format 1 and the recording format dual-layer corresponding to the recording format 2 is the recording destination of the characteristic data or the special reproduction data, which has been described with reference to FIG. 10, even if the recording format is changed, the characteristic data or the special reproduction data is recorded on the other area without change.

12.2 Changing Recording Rates

Here, a description will be given of the case of changing recording rates for the processing of the case where insufficient recording capacity has been detected.

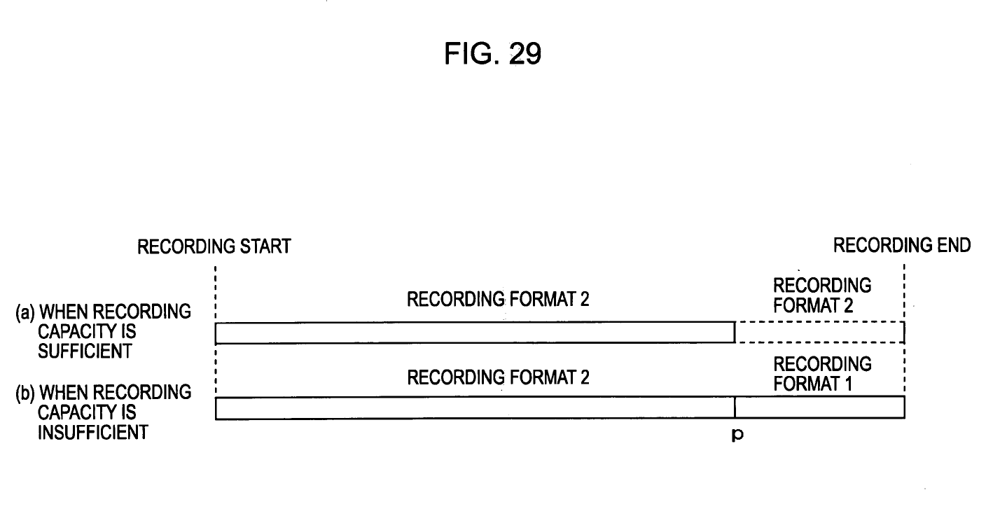

Such a change of the recording rate is performed, for example as shown in FIG. 29, in accordance with the remaining recording capacity of the recording medium B. Here, the recording format 1 is a normal-quality recording mode, and the recording format 2 is a high-quality recording mode. In the normal-quality recording mode, recording is performed at a normal recording rate, and in the high-quality recording mode, recording is performed at a recording rate higher than the normal recording rate.

As shown in FIG. 29, (a), when the recording capacity of the recording medium B is sufficient, if recording is continued in the recording format 2, the recording in the recording format 2 is continued until the end of the recording. On the other hand, as shown in FIG. 29, (b), when the recording capacity of the recording medium B is insufficient, if the recording is continued in the recording format 2, the recording format is changed from the recording format 2 to the recording format 1 at a predetermined point p, and then the recording is performed in the recording format 1 until the end of the recording.

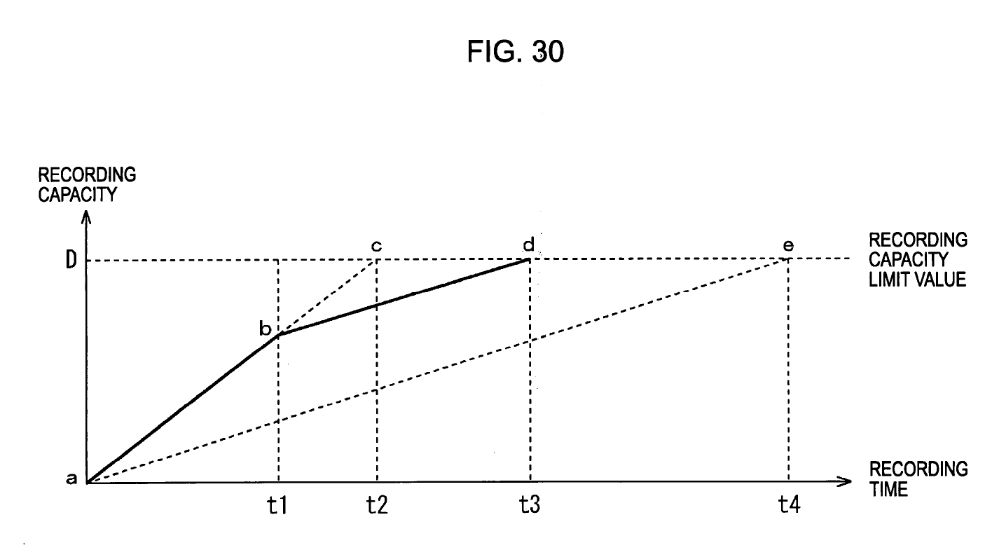

FIG. 30 is a diagram illustrating an example of a characteristic between recording time and the amount of recording for each recording format (recording rate).

The characteristic from point a to point c shows the chapter of the case of recording in the recording format 2 (high recording rate). If the recording in the recording format 2 is continued, the amount of data recorded reaches the maximum recording capacity D (recording capacity limit value) of the recording medium B at time t2.

The characteristic from point a to point e shows the chapter of the case of recording in the recording format 1 (normal recording rate). If the recording in the recording format 1 is continued, the amount of data recorded reaches the maximum recording capacity D of the recording medium B at time t4.

As shown in FIG. 30, if there is a limit of the recording capacity, the recording allowed time when recording is performed in the high-quality mode (recording format 2) is shorter than the recording allowed time when recording is performed in the normal-quality mode (recording format 1).

Thus, when recording is performed in the recording mode of the recording format 2, and as shown in FIG. 30, by changing the recording mode to the recording format 1 at the point t1 in time, which is earlier time than time t2 at which the amount of data recorded reaches the maximum recording capacity D, it becomes possible to record until time t3, whereas the recording is possible until the time t2 if the recording mode is not changed.

In this case, when the characteristic extraction processing is performed using the data which has been subjected to the band compression processing, such as MPEG, the processing is performed using the data obtained in the process of recording in the recording format 2 until the time t1, and after the time t1 at which the recording format has been changed, the data obtained in the process of recording in the recording format 1.

In this manner, by changing the data to be used for the characteristic extraction processing in accordance with the recording mode and the recording format, it becomes possible to generate the special reproduction data.

13. Operation Flowchart

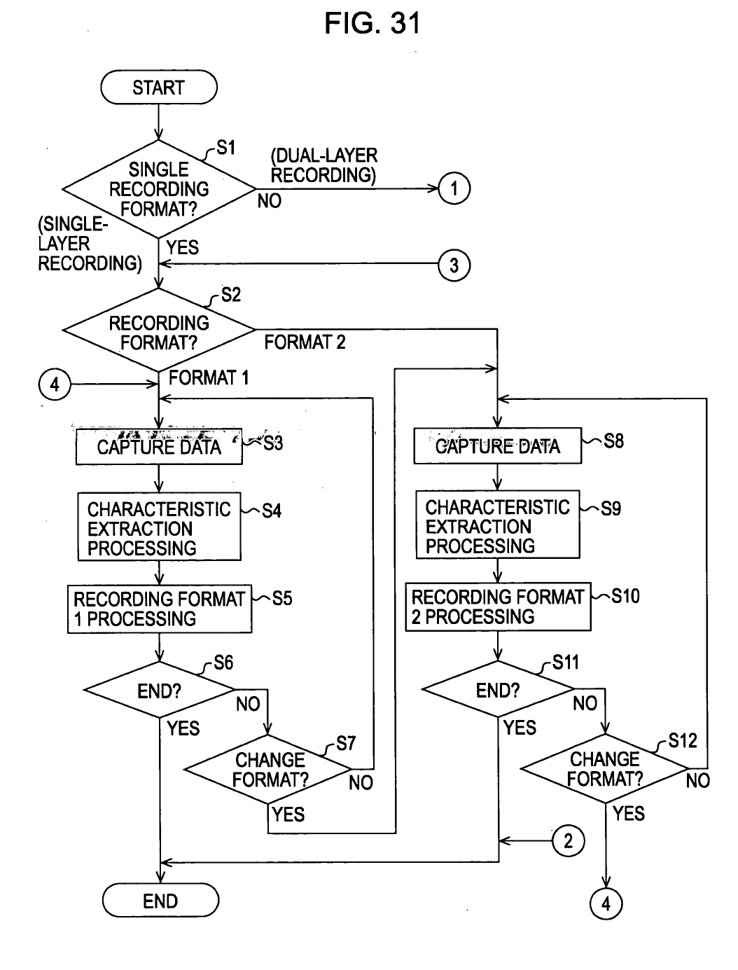

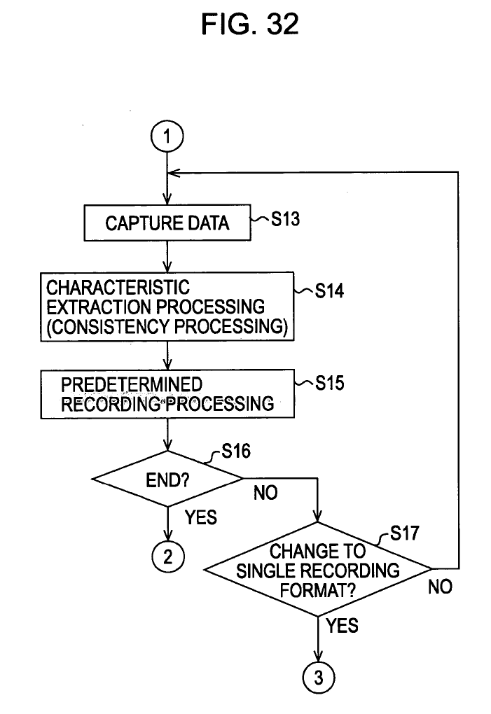

Next, a description will be given of the recording processing by the recording/reproducing apparatus with reference to the flowcharts in FIGS. 31 and 32.

Here, suppose that a recording medium B corresponds to the data recording in a plurality of formats, and the video/audio data to be recorded is one stream as shown in FIG. 3.

In step S1, a determination is made on whether the target video/audio data is to be recorded by a single recording format. If it is determined to be recorded by a single recording format, the processing proceeds to step S2.

That is to say, a determination is made on whether the recording medium B corresponds to two formats, the recording format 1 and the recording format 2. If determined that it is corresponding to two formats, a further determination is made on whether the recording is performed on both of the recording layers corresponding to individual recording formats, or the recording is performed on either one of the recording formats. A determination on which recording format the recording medium B corresponds to is made on the basis of, for example the detection result of error rate by recording test data of the recording format 1 and recording format 2 as described above.

In step S2, a determination is made on whether the video/audio data to be processed is recorded in the recording format 1 or in the recording format 2. This determination is made, for example on the basis of the user's selection operation or on the basis of the automatic identification of the type of the input video/audio data.

For example, in FIG. 16 or FIG. 19, when high-definition broadcasting is received by a receiving system 42 and the program thereof is recorded, the recording format 2 is automatically selected as the recording format of the video/audio data here in order to record with high quality as much as possible. Such an automatic determination is made by a system controller system 60 on the basis of the input of the meta-data and the identification information of the program from the receiving system 42 to the system controller system 60.

In step S2, if it is determined that the video/audio data to be processed is recorded in the recording format 1, the processing proceeds to step S3, and data capturing is performed. The captured data is input to the characteristic extraction processing system 50.

In step S4, the characteristic extraction processing system 50 performs the characteristic extraction processing, and the characteristic data is detected. The detected characteristic data is appropriately input into a playlist data (chapter data) generation processing system 59, and the playlist data (chapter data) generation processing system 59 generates special reproduction data. The characteristic data and the special reproduction data obtained here are input into a recording processing system 46.

The extraction of the characteristic data, generation of the special reproduction data, and the recording thereof are performed by the following methods, for example.

A method of capturing data for each predetermined section or for each predetermined amount of data, performing the detection of the characteristic data and the generation of the playlist data, and recording the data onto the recording medium B (processing method 1).

A method of reading the video/audio data after the completion of the recording of all video/audio data, performing the detection of the characteristic data and the generation of the playlist data, and recording the data again onto a predetermined area or position (processing method 2).

A method of detecting the characteristic data simultaneously with the recording of video/audio data, recording the detected characteristic data onto the recording medium B along with the video/audio data, reading only the characteristic data after completion of recording, and recording the playlist data generated based on the read characteristic data onto the recording medium B (processing method 3). The playlist data generated at this time can be used for the special reproduction of the video/audio data recorded on the recording medium B.

In step S5, the video/audio data, etc., is subjected to predetermined recording processing, and the video/audio data is recorded on the recording format single-layer of the recording medium B.

In step S6, a determination is made on whether the recording is completed. If determined to be completed, the processing is completed. On the other hand, if determined not to be completed, the processing proceeds to step S7.

In step S7, a determination is made on whether the recording format is to be changed. If determined not to be changed, the processing returns to step S3, and the subsequent processing is repeated.

In step S7, if the recording format is determined to be changed, the processing proceeds to step S8, and the subsequent processing is performed. Also, in step S2, if the video/audio data to be processed is determined to be recorded in the recording format 2, the processing proceeds to step S8, and the subsequent processing is performed.

In step S8, data is captured. The captured data is input into the characteristic extraction processing system 50.

In step S9, the characteristic extraction processing system 50 performs the characteristic extraction processing to detect the characteristic data. The detected characteristic data is appropriately input into the playlist data (chapter data) generation processing system 59, and the playlist data (chapter data) generation processing system 59 performs the generation of the special reproduction data. The characteristic data and the special reproduction data obtained here is input into the recording processing system 46.

In step S10, the video/audio data, etc., is subjected to predetermined recording processing, and the video/audio data is recorded on the recording format dual-layer of the recording medium B.

In step S11, a determination is made on whether the recording is completed. If determined to be completed, the processing is completed. On the other hand, if determined not to be completed, the processing proceeds to step S12.

In step S12, a determination is made on whether the recording format is to be changed. If determined not to be changed, the processing returns to step S8, and the subsequent processing is repeated.

In step S12, if the recording format is determined to be changed, the processing proceeds to step S3, and the subsequent processing is performed. For example, when the recording capacity of the recording format dual-layer of the recording medium B becomes insufficient in order to record the entire video/audio data to be processed, a determination is made here to change the recording format, and the recording in the recording format 1 is started.

On the other hand, in step S1, if a determination is made that the video/audio data to be processed is not recorded in a single recording format, that is to say, is recorded in a plurality of recording formats, the processing proceeds to step S13 (FIG. 32).

In step S13, data is captured. The captured data is input into the characteristic extraction processing system 50.

In step S14, the characteristic extraction processing system 50 performs the characteristic extraction processing to detect the characteristic data. The detected characteristic data is appropriately input into the playlist data (chapter data) generation processing system 59, and the playlist data (chapter data) generation processing system 59 performs the generation of the special reproduction data. The characteristic data and the special reproduction data obtained here is input into the recording processing system 46.

In this regard, the extraction processing of the characteristic data and the generation processing of the special reproduction data here are performed such that the consistency of the obtained characteristic data and the special reproduction data is ensured between the case where the video/audio data of the recording format 1 and the case where the video/audio data of the recording format 2.

In step S15, the video/audio data, etc., is subjected to predetermined recording processing, and the video/audio data is recorded on the recording format single-layer and the recording format dual-layer of the recording medium B. The characteristic data and the special reproduction data obtained so as to ensure consistency are also recorded on the predetermined area of the recording medium B.

In step S16, a determination is made on whether the recording is completed. If determined to be completed, the processing is completed. On the other hand, if not to be completed, the processing proceeds to step S17.

In step S17, a determination is made on whether the recording format is to be changed to a single recording format. If determined not to be changed, the processing returns to step S13, and the subsequent processing is repeated.

In step S17, if the recording format is determined to be changed to a single recording format, the processing proceeds to step S2, and the subsequent processing is performed.

In the above, as a format capable of recording at higher quality than the normal DVD, the BD format or the HD-DVD format is used. However, the format is not limited to this. For example, one format having versatility for both of the BD format and the HD-DVD format may be used.

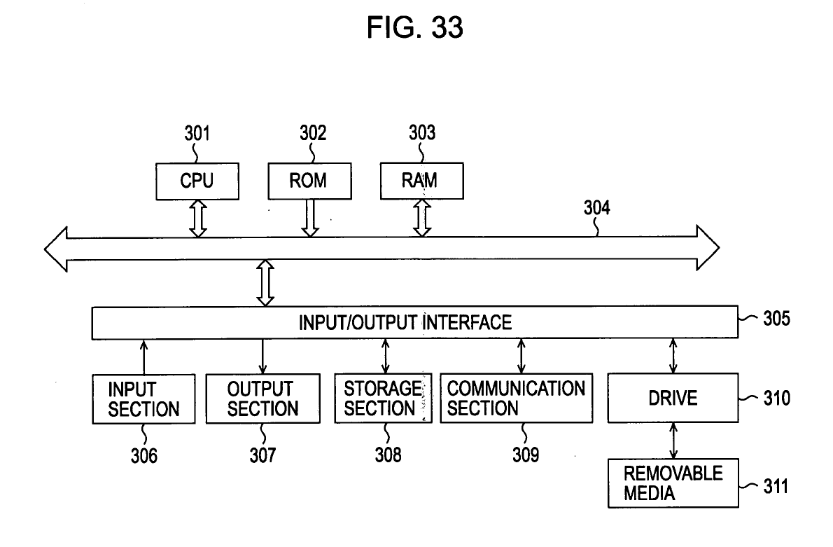

A series of processing described above may be executed by hardware, but may also be executed by software. In this case, the apparatus for executing the software is, constituted by, for example a personal computer as shown in FIG. 33.

In FIG. 33, a CPU (Central Processing Unit) 301 executes various processing in accordance with programs stored in a ROM (Read Only Memory) 302 or programs loaded from a storage section 308 to a RAM (Random Access Memory) 303. The RAM 303 also stores the data necessary for the CPU 301 to execute various processing appropriately.

The CPU 301, the ROM 302, and the RAM 303 are mutually connected through a bus 304. An input/output interface 305 is also connected to the bus 304.

An input section 306 including a keyboard, a mouse, etc., an output section 307 including a display such as a LCD (Liquid Crystal Display), etc., a speaker, etc., a storage section 308 including a hard disk, etc., a communication section 309 for performing communication processing through a network are connected to the input/output interface 305.

A drive 310 is also connected to the input/output interface 305 as necessary. A removable media 311 including a magnetic disk, an optical disc, a magneto-optical disc, or a semiconductor memory is appropriately mounted to the drive 310, and computer programs read therefrom are installed in the storage section 308 as necessary.

When a series of processing is executed by software, the programs constituting the software are built in a dedicated hardware of a computer. Alternatively, the various programs are installed in, for example a general-purpose personal computer capable of executing various functions from a network or a recording medium.

As shown in FIG. 33, the recording media include not only a removable media 311 including a magnetic disk (including a flexible disk) recording programs, an optical disc (CD-ROM (Compact Disk-Read Only. Memory)), a DVD (Digital Versatile Disk), a magneto-optical disc (including. MD (a registered trademark) (Mini-Disk)), or a semiconductor memory, which are distributed in order to provide a user with the programs separately from the apparatus main unit. Also the recording media include the ROM 302, which is provided to the user in a built-in state in the apparatus main unit, the hard disk included in the storage section 308, and the like.

In this regard, in this specification, each step includes the processing to be performed in time series in accordance with the described sequence as a matter of course. Also, each step includes the processing which is not necessarily executed in time series, but is executed in parallel or individually.

It should be understood by those skilled in the art that various modifications, combinations, sub-combinations and alterations may occur depending on design requirements and other factors insofar as they are within the scope of the appended claims or the equivalents thereof.

1. An information processing apparatus for capturing an input stream in a plurality of recording formats and recording a plurality of the captured streams on a same recording medium, the apparatus comprising:
extracting means for extracting from the input stream characteristic data representing characteristics of the stream; and
recording means for recording the extracted characteristic data, predetermined data based on the extracted characteristic data, or both the extracted characteristic data and the predetermined data as common data representing the characteristics of the streams individually captured in the plurality of recording formats.

2. The information processing apparatus according to claim 1, wherein
the recording medium is an optical disc including a plurality of recording layers capable of recording the plurality of captured streams with each recording layer recording a captured stream of a different recording format, and
the recording means records the extracted characteristic data on at least one of the plurality of recording layers.

3. The information processing apparatus according to claim 2, wherein when a semiconductor memory is provided as a recording area different from the recording layers, the recording means records the extracted characteristic data on at least one of the plurality of recording layers or the semiconductor memory.

4. The information processing apparatus according to claim 1, further comprising generation means for generating special reproduction data to be used at a special reproduction time of the streams recorded on the recording medium as the predetermined data based on the extracted characteristic data.

5. A method of information processing for capturing an input stream in a plurality of recording formats and recording a plurality of the captured streams on a same recording medium, the method comprising:
extracting from the input stream characteristic data representing characteristics of the stream; and
recording the extracted characteristic data, predetermined data based on the extracted characteristic data, or both the extracted characteristic data and the predetermined data as common data representing the characteristics of the streams individually captured in the plurality of recording formats.

6. The method of information processing according to claim 5, wherein
the recording medium is an optical disc including a plurality of recording layers capable of recording the plurality of captured streams with each recording layer recording a captured stream of a different recording format, and
the recording step records the extracted characteristic data on at least one of the plurality of recording layers.

7. The method of information processing according to claim 6, wherein when a semiconductor memory is provided as a recording area different from the recording layers, the recording step records the extracted characteristic data on at least one of the plurality of recording layers or the semiconductor memory.

8. The method of information processing according to claim 5, further comprising generating special reproduction data to be used at a special reproduction time of the streams recorded on the recording medium as the predetermined data based on the extracted characteristic data.

9. A program for causing a computer to execute processing for capturing an input stream in a plurality of recording formats and recording the plurality of captured streams on a same recording medium, the program comprising:
extracting from the input stream characteristic data representing characteristics of the stream; and
recording the extracted characteristic data, predetermined data based on the extracted characteristic data, or both the extracted characteristic data and the predetermined data as common data representing the characteristics of the streams individually captured in the plurality of recording formats.

10. An information processing apparatus for processing data recorded on a recording medium including a plurality of recorded streams obtained by capturing one stream in a plurality of recording formats, the apparatus comprising:
when characteristic data representing characteristics of the stream extracted from the stream is not recorded on the recording medium, extracting means for reading any one of the streams recorded on the recording medium and for extracting characteristic data representing characteristics of the stream from the read stream; and
recording means for recording the extracted characteristic data, predetermined data based on the extracted characteristic data, or both the extracted characteristic data and the predetermined data as common data representing the characteristics of the streams individually captured in the plurality of recording formats.

11. The information processing apparatus according to claim 7, wherein
the recording medium is an optical disc including a plurality of recording layers capable of recording the plurality of captured streams with each recording layer recording a captured stream of a different recording format, and
the recording means records the extracted characteristic data on at least one of the plurality of recording layers.

12. The information processing apparatus according to claim 8, wherein when a semiconductor memory is provided as a recording area different from the recording layers, the recording means records the extracted characteristic data on at least one of the plurality of recording layers or the semiconductor memory.

13. The information processing apparatus according to claim 7, further comprising generation means for generating special reproduction data to be used at a special reproduction time of the streams recorded on the recording medium as the predetermined data based on the extracted characteristic data.

14. A method of information processing for processing data recorded on a recording medium including a plurality of recorded streams obtained by capturing one stream in a plurality of recording formats, the method comprising:
when characteristic data representing characteristics of the stream extracted from the stream is not recorded on the recording medium, reading any one of the streams recorded on the recording medium and extracting characteristic data representing characteristics of the stream from the read stream; and
recording the extracted characteristic data, predetermined data based on the extracted characteristic data, or both the extracted characteristic data and the predetermined data as common data representing the characteristics of the streams individually captured in the plurality of recording formats.

15. The method of information processing according to claim 14, wherein
the recording medium is an optical disc including a plurality of recording layers capable of recording the plurality of captured streams with each recording layer recording a captured stream of a different recording format, and
the recording step records the extracted characteristic data on at least one of the plurality of recording layers.

16. The method of information processing according to claim 15, wherein when a semiconductor memory is provided as a recording area different from the recording layers, the recording step records the extracted characteristic data on at least one of the plurality of recording layers or the semiconductor memory.

17. The method of information processing according to claim 14, further comprising generating special reproduction data to be used at a special reproduction time of the streams recorded on the recording medium as the predetermined data based on the extracted characteristic data.

18. A program for causing a computer to process data recorded on a recording medium including a plurality of recorded streams obtained by capturing one stream in a plurality of recording formats, the program comprising:
when characteristic data representing characteristics of the stream extracted from the stream is not recorded on the recording medium, reading any one of the streams recorded on the recording medium and extracting characteristic data representing characteristics of the stream from the read stream; and
recording the extracted characteristic data, predetermined data based on the extracted characteristic data, or both the extracted characteristic data and the predetermined data as common data representing the characteristics of the streams individually captured in the plurality of recording formats.

19. An information processing apparatus for capturing an input stream in a plurality of recording formats and recording a plurality of the captured streams on a same recording medium, the apparatus comprising:
an extracting unit operable to extract from the input stream characteristic data representing characteristics of the stream; and
a recording unit operable to record the extracted characteristic data, predetermined data based on the extracted characteristic data, or both the extracted characteristic data and the predetermined data as common data representing the characteristics of the streams individually captured in the plurality of recording formats.

20. An information processing apparatus for processing data recorded on a recording medium including a plurality of recorded streams obtained by capturing one stream in a plurality of recording formats, the apparatus comprising:
when characteristic data representing characteristics of the stream extracted from the stream is not recorded on the recording medium, an extracting unit operable to read any one of the streams recorded on the recording medium and to extract characteristic data representing characteristics of the stream from the read stream; and
a recording unit operable to record the extracted characteristic data, predetermined data based on the extracted characteristic data, or both the extracted characteristic data and the predetermined data as common data representing the characteristics of the streams individually captured in the plurality of recording formats.
